(19) United States
(12) Patent Application Publication
(10) Pub. No.: US 2008/0107832 A1
(43) Pub. Date: May 8, 2008

(54) Optical Film, Process of Producing the Same, Polarizing Plate Including the Same, and Liquid Crystal Display

(75) Inventor: Jun Takeda, Minami-Ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/864,395

(22) Filed: Sep. 28, 2007

(30) Foreign Application Priority Data
Sep. 29, 2006 (JP) 2006-268716

(51) Int. Cl. C09K 19/00; B32B 27/32; B29D 11/00

(52) U.S. Cl. 428/1.4; 428/220; 264/1.6

(57) ABSTRACT

An optical film has a thickness of from 20 to 60 μm, contains a cyclic olefin resin, and satisfies the following conditions (1) to (3):
0≦Re≦75 (1)
20≦Rth≦255 (2)
200≦D≦1000 (3) where Re is an in-plane retardation at a wavelength of 590 nm; Rth is a retardation in a thickness direction at a wavelength of 590 nm; and D is a moisture permeability at 40° C. and 90% RH.

### FIELD OF THE INVENTION

This invention relates to an optical film, a process of producing the film, a polarizing plate including the film, and a liquid crystal display (LCD). More particularly, it relates to an optical film having a sufficiently small thickness allowing for size and thickness reduction of LCDs, proper optical characteristics such as retardation properties, and good adhesion to a polarizer, a process of producing the optical film, and a polarizing plate and an LCD including the optical film.

### BACKGROUND OF THE INVENTION

A polarizing plate is generally composed of a polarizer made of a polyvinyl alcohol (PVA) film having iodine or a dichroic dye adsorbed and oriented therein and a protective film disposed on each side of the polarizer. Cellulose triacetate is widely used with preference as a polarizer protective film to provide a polarizing plate because of its advantages such as toughness, flame retardancy, and high optical isotropy (i.e., low retardation). An LCD is basically composed of a liquid crystal cell and a polarizing plate. An LCD of high display qualities has been realized by inserting an optical compensation film between a polarizing plate and a liquid crystal cell as described in JP-A-8-50206. In these applications, however, a cellulose triacetate film is hygroscopic and therefore has poor dimensional stability, easily undergoing changes in optical compensation performance or easily separating from the polarizer.

To settle the problem, use of a film other than cellulose triacetate has been attempted. Candidates include polycarbonate (PC), polyethylene terephthalate (PET), and cyclic polyolefins. Cyclic polyolefins, which have a flat molecular structure, are suited in applications where optical characteristics for use as a polarizer protective film, in particular, relatively high retardations in a thickness direction are demanded as in application to vertical alignment mode LCDs.

The problems arising from use of a cyclic polyolefin film consist in poor adhesion to a PVA-based polarizer and far lower moisture permeability than cellulose triacetate film ascribed to the cyclic structure and the characteristics of the functional groups proposed hereinbefore. The former problem has been nearly solved by the improvements, e.g., on pressure sensitive adhesives to be used, whilst the latter problem still exists. That is, the water used to treat the polarizer's surface cannot escape from between the polarizer and the protective film and can affect the adhesion between the polarizer and the protective film or deteriorate the polarizer.

### SUMMARY OF THE INVENTION

An object of the present invention is to overcome the above described problems of conventional techniques. The invention provides an optical film having a sufficiently small thickness to achieve size and thickness reduction of LCDs, proper optical characteristics such as retardation properties, and good adhesion to a polarizer, a process of producing the optical film, a polarizing plate including the optical film, and an LCD including the optical film.

Cyclic polyolefins can be designed to have increased moisture permeability by altering their cyclic structure or introducing a hydrophilic functional group. The inventors have succeeded in designing a cyclic polyolefin film having reduced humidity dependence and desired moisture permeability as well as a small thickness and satisfactory optical characteristics.

As a result of extensive investigations, the inventors have found that the conventional technical problems are eliminated by the following invention.

The present invention provides, in its first aspect, an optical film having a thickness of 20 to 60 μm, containing a cyclic olefin resin, and satisfying conditions (1) to (3):
0≦Re≦75 (1)
20≦Rth≦255 (2)
200≦D≦1000 (3)
where Re is an in-plane retardation at a wavelength 590 nm; Rth is a retardation in the thickness direction (hereinafter “thickness direction retardation”) at a wavelength 590 nm; and D is a moisture permeability at 40° C. and 90% RH.

The present invention provides the following preferred embodiments of the above-described optical film.

(i) The optical film which satisfies conditions (4) and (5):
ΔRe(25° C.,10% RH−25° C.,80% RH)≦4 (4)
ΔRth((25° C.,10% RH−25° C.,80% RH)≦8 (5)
where ΔRe (25° C., 10% RH−25° C., 80% RH) is a difference between the in-plane retardation value at 590 nm after standing in an atmosphere of 25° C. and 10% RH for 24 hours and that after standing in an atmosphere of 25° C. and 80% RH for 24 hours; and ΔRth(25° C., 10% RH−25° C., 80% RH) is a difference between the thickness direction retardation value at 590 nm after standing in an atmosphere of 25° C. and 10% RH for 24 hours and that after standing in an atmosphere of 25° C. and 80% RH for 24 hours.
(ii) The optical film which contains at least one cyclic olefin resin selected from the group consisting of (A-1) an addition copolymer containing at least one repeating unit represented by formula (I) shown below and at least one repeating unit represented by formula (II) shown below, (A-2) an addition polymer containing at least one repeating unit represented by formula (II), and (A-3) a ring-opening polymer containing at least one repeating unit represented by formula (III) shown below. 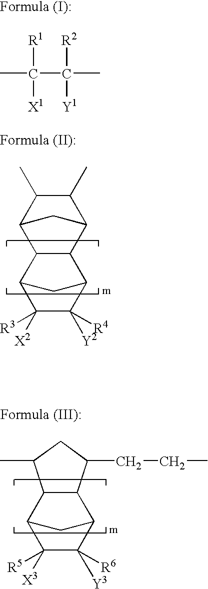
wherein m represents an integer of 0 to 4; R¹, R², R³, R⁴, R⁵, and R⁶ each represent a hydrogen atom or a hydrocarbon group having 1 to 10 carbon atoms; X¹, X², X³, Y¹, Y², and Y³ each represent a hydrogen atom, a hydrocarbon group having 1 to 10 carbon atoms, a halogen atom, a halogen-substituted hydrocarbon group having 1 to 10 carbon atoms, —(CH₂)ₙCOOR¹¹, —(CH₂)ₙOCOR¹², —(CH₂)ₙNCO, —(CH₂)ₙNO₂, —(CH₂)ₙCN, —(CH₂)ₙCONR¹³R¹⁴, —(CH₂)ₙR¹³R¹⁴, —(CH₂)ₙOZ, or —(CH₂)ₙW; or X¹ and Y¹ are taken together, X² and Y² are taken together, or X³ and Y³ are taken together, each to form (—CO)₂O or (—CO)₂NR¹⁵; R¹¹, R¹², R¹³, R¹⁴, and R¹⁵ each represent a hydrogen atom or a hydrocarbon group having 1 to 20 carbon atoms; Z represents a hydrocarbon group or a halogen-substituted hydrocarbon group; W represents SiR¹⁶ₚD₃₋ₚ; R¹⁶ represents a hydrocarbon group having 1 to 10 carbon atoms; D represents a halogen atom, —OCOR¹⁶ or —OR¹⁶; p represents an integer of 0 to 3; and n represents an integer of 0 to 10.
(iii) The optical film which contains an additive that reduces an Rth.
(iv) The optical film which contains, as an additive for reducing an Rth, 0.01% to 30% by weight of at least one compound represented by formulae (IV) or (V) shown below based on the cyclic olefin resin on a solid basis. 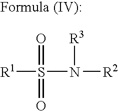
wherein R¹ represents an alkyl group or an aryl group; R² and R³ each represent a hydrogen atom, an alkyl group or an aryl group; provided that the total carbon atom number of R¹, R², and R³ is 10 or more. 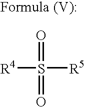
wherein R⁴ and R⁵ each represent an alkyl group or an aryl group,
provided that the total carbon atom number of R⁴ and R⁵ is 10 or more.
(v) The optical film which contain, as an additive for reducing an Rth, 0.01% to 30% by weight of at least one compound represented by formulae (VI) through (VIII) shown below based on the cyclic olefin resin on a solid basis. 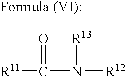
wherein R¹¹ represents an aryl group; R¹² and R¹³ each represent a substituted or unsubstituted alkyl group or a substituted or unsubstituted aryl group, provided that at least one of R¹² and R¹³ is an aryl group. 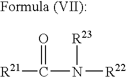
wherein R²¹, R²², and R²³ each represent a substituted or unsubstituted alkyl group. 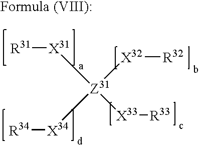
wherein R³¹, R³², R³³, and R³⁴ each represent a hydrogen atom, a substituted or unsubstituted aliphatic group or a substituted or unsubstituted aromatic group; X³¹, X³², X³³, and X³⁴ each represent a single bond or a divalent linking group composed of at least one of —CO— and NR³⁵—; R³⁵ represents a substituted or unsubstituted aliphatic group or a substituted or unsubstituted aromatic group; a, b, c, and d each represent an integer of 0 or greater, provided that a+b+c+d is 2 or greater; and Z³¹ represents an acylic organic group having a valence of (a+b+c+d).

(VI) The optical which contains 0.01% to 30% by weight of at least one compound represented by formula (IX) or (X) shown below based on the cyclic olefin resin on a solid basis:

wherein R⁴¹ to R⁴⁸ each independently represent a hydrogen atom, a halogen atom, a substituted or unsubstituted hydrocarbon group having 1 to 30 carbon atoms which may have a linking group containing an oxygen atom, a sulfur atom, a nitrogen atom or a silicon atom, or a polar group; and R⁴⁴s may be either all the same atoms or groups or different atoms or groups, or R⁴⁴s may be bonded together to form a carbocycle or a heterocycle (which may either have a monocyclic structure or be fused to another cycle to form a polycyclic structure).

(VII) The optical film which contains 0.01% to 30% by weight of at least one polyester polymer based on the cyclic olefin resin on a solid basis.

The invention also provides, in its second aspect, a process of producing the optical film of the invention. The process includes the steps of dissolving a cyclic olefin resin in an organic solvent to prepare a dope (dope preparation step), casting the dope on a support (casting step), peeling the cast film from the support (peeling step), drying the cast film (drying step), and taking up the film (winding step).

The invention also provides, in its third aspect, a polarizing plate including a polarizer and a protective film on each side of the polarizer. At least one of the protective films is the optical film of the invention.

The invention also provides, in its fourth aspect, an LCD including a liquid crystal cell and polarizing plates each disposed on each side of the liquid crystal cell. At least one of the polarizing plates is the polarizing plate of the invention.

The optical film of the invention is thin enough to achieve size and thickness reduction of LCDs and exhibits proper optical characteristics such as retardation properties and good adhesion to a polarizer.

### DETAILED DESCRIPTION OF THE INVENTION

The optical film of the invention will hereinafter be also referred to as a cyclic polyolefin film. The cyclic polyolefin film contains at least a cyclic olefin resin. The cyclic olefin resin will hereinafter be also referred to as a cyclic polyolefin resin or a cyclic polyolefin.

The optical film has a thickness of 20 to 60 μm and satisfies conditions (1) through (3):
0≦Re≦75 (1)
20≦Rth≦255 (2)
200≦D≦1000 (3)
where Re is an in-plane retardation at a wavelength 590 nm; Rth is a thickness direction retardation at a wavelength 590 nm; and D is a moisture permeability at 40° C. and 90% RH.

Means for controlling the film thickness and satisfying conditions (1) to (3) are not particularly limited. For example, Re adjustment can be achieved by stretching, and Rth adjustment by the addition of an additive. While D is largely dependent on the structure of the film, it is somewhat adjustable with an additive. Additionally, film thickness is influential on all of conditions (1) to (3).

As used herein, the term “cyclic polyolefin resin” is a generic term including polymer resins having a cyclic polyolefin structure.

Examples of the polymer resins having a cyclic olefin structure that can be used in the invention include (1) norbornene polymers, (2) monocyclic olefin polymers, (3) cyclic conjugated diene polymers, (4) vinyl alicyclic hydrocarbon polymers, and (5) hydrogenation products of the polymers (1) to (4). Of these cyclic polyolefins preferred are an addition (co)polymer containing at least one repeating unit represented by formula (II) shown below and, where necessary, at least one repeating unit represented by formula (I) shown below. Ring opening (co) polymers containing at least one repeating unit represented by formula (III) shown below are also preferred. 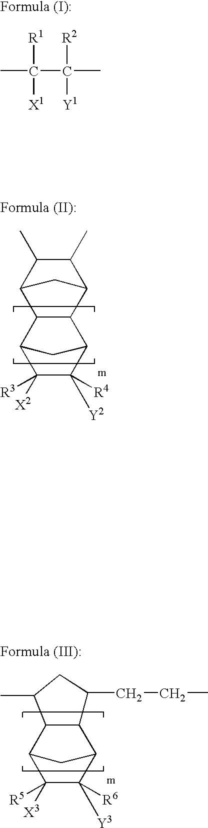
wherein m represents an integer of 0 to 4; R¹, R², R³, R⁴, R⁵, and R⁶ each represent a hydrogen atom or a hydrocarbon group having 1 to 10 carbon atoms; X¹, X², X³, Y¹, Y², and Y³ each represent a hydrogen atom, a hydrocarbon group having 1 to 10 carbon atoms, a halogen atom, a halogen-substituted hydrocarbon group having 1 to 10 carbon atoms, —(CH₂)ₙCOOR¹¹, —(CH₂)ₙOCOR¹², —(CH₂)ₙNCO, —(CH₂)ₙNO₂, —(CH₂)ₙCN, —(CH₂)ₙCONR¹³R¹⁴, —(CH₂)ₙNR¹³R¹⁴, —(CH₂)ₙOZ, or —(CH₂)ₙW; or X¹ and Y¹ are taken together, X² and Y² are taken together, or X³ and Y³ are taken together, each to form (—CO)₂O or (—CO)₂NR¹⁵; R¹¹, R¹², R¹³, R¹⁴, and R¹⁵ each represent a hydrogen atom or a hydrocarbon group having 1 to 20 carbon atoms; Z represents a hydrocarbon group or a halogen-substituted hydrocarbon group; W represents SiR¹⁶ₚD₃₋ₚ; R¹⁶ represents a hydrocarbon group having 1 to 10 carbon atoms; D represents a halogen atom, —OCOR¹⁶ or —OR¹⁶; p represents an integer of 0 to 3; and n represents an integer of 0 to 10.

Introducing a functional group having large polarity as substituent X¹, X², X³, Y¹, Y², or Y³ results in the formation of a film with an increased thickness direction retardation (Rth) and enhanced in-plane retardation (Re) developability. A film with enhanced Re developability is a film that comes to exhibit an increased Re value on being stretched in the optical film production line.

The norbornene addition (co)polymers are disclosed in JP-A-10-7732, JP-A-2002-504184, US 2004229157A1 and WO 2004/070463A1. They are obtained by addition polymerization of a norbornene polycyclic unsaturated compound(s). According to need, the norbornene polycyclic unsaturated compound can be addition copolymerized with ethylene, propylene, butene, a conjugated diene such as butadiene or isoprene, a non-conjugated diene such as ethylidenenorbornene, or a linear diene compound such as acrylonitrile, acrylic acid, methacrylic acid, maleic anhydride, an acrylic ester, a methacrylic ester, maleimide, vinyl acetate or vinyl chloride. Commercially available norbornene addition (co)polymers are useful, including APL (trade name) series of different grades according to the glass transition temperature (Tg) available from Mitsui Chemicals, Inc., e.g., APL 8008T (Tg: 70° C.), APL 6013T (Tg: 125° C.), and APL 6015T (Tg: 145° C.); pellets TOPAS 8007, 6013, and 6015 from Polyplastics Co., Ltd.; and Appear 300 from Ferrania S.p.A.

Hydrogenation products of the norbornene polymers are obtained by addition polymerization or ring-opening metathesis polymerization of a polycyclic unsaturated compound followed by hydrogenation as taught in JP-A-1-240517, JP-A-7-196736, JP-A-60-26024, JP-A-62-19801, JP-A-2003-1159767, and JP-A-2004-309979. In the norbornene polymers, R⁵ and R⁶ are each preferably a hydrogen atom or —CH₃; X³ and Y³ are each preferably a hydrogen atom, Cl or —COOCH₃; and other substituents are selected appropriately. Commercially available norbornene resins are also useful, including Arton G or Arton F from JSR Corp. and Zeonor ZF14 and ZF16 and Zeonex 250 and 280 from Zeon Corp.

The cyclic polyolefin resin that can be used in the invention preferably has a polystyrene equivalent weight average molecular weight (Mw) of 5,000 to 1,000,000, more preferably 10,000 to 500,000, even more preferably 50,000 to 300,000, measured by gel-permeation chromatography (GPC). The molecular weight distribution in terms of Mw/Mn (Mn: number average molecular weight measured by GPC) is preferably 10 or smaller, more preferably 5.0 or smaller, even more preferably 3.0 or smaller. The glass transition temperature (Tg) is preferably 50° to 350° C., more preferably 80° to 330° C., even more preferably 100° to 300° C., measured by DSC.

The optical film may contain a retardation decreasing agent, inclusive of an Rth decreasing agent and an Re decreasing agent. Examples of suitable retardation decreasing agents that can be used in the invention include, but are not limited to, the compounds represented by formulae (IV) to (X) and polyester polymers.

In formula (IV), R¹ is an alkyl group or an aryl group, and R² and R³ are each a hydrogen atom, an alkyl group or an aryl group. The total number of carbon atoms in R¹, R², and R³ is 10 or greater.

In formula (V), R⁴ and R⁵ are each an alkyl group or an aryl group. The total number of carbon atoms in R⁴ and R⁵ is 10 or greater. The alkyl and aryl group may have a substituent. Examples of preferred substituents include a fluorine atom, an alkyl group, an aryl group, an alkoxy group, a sulfone group, and a sulfonamido group, with an alkyl group, an aryl group, an alkoxy group, a sulfone group, and a sulfonamido group being still preferred. The alkyl group may be straight, branched or cyclic. The alkyl group preferably contains 1 to 25 carbon atoms, more preferably 6 to 25 carbon atoms, even more preferably 6 to 20 carbon atoms. Examples of the C6-C20 alkyl groups are methyl, ethyl, propyl, isopropyl, butyl, isobutyl, t-butyl, amyl, isoamyl, t-amyl, hexyl, cyclohexyl, heptyl, octyl, bicyclooctyl, nonyl, adamantyl, decyl, t-octyl, undecyl, dodecyl, tridecyl, tetradecyl, pentadecyl, hexadecyl, heptadecyl, octadecyl, nonadecyl, and didecyl. The aryl group preferably contains 6 to 30 carbon atoms. More preferred are those containing 6 to 24 carbon atoms, including phenyl, biphenyl, terphenyl, naphthyl, binaphthyl, and triphenylphenyl. Specific examples of the compounds of formulae (IV) and (V) are shown below for illustrative purposes only but not for limitation.

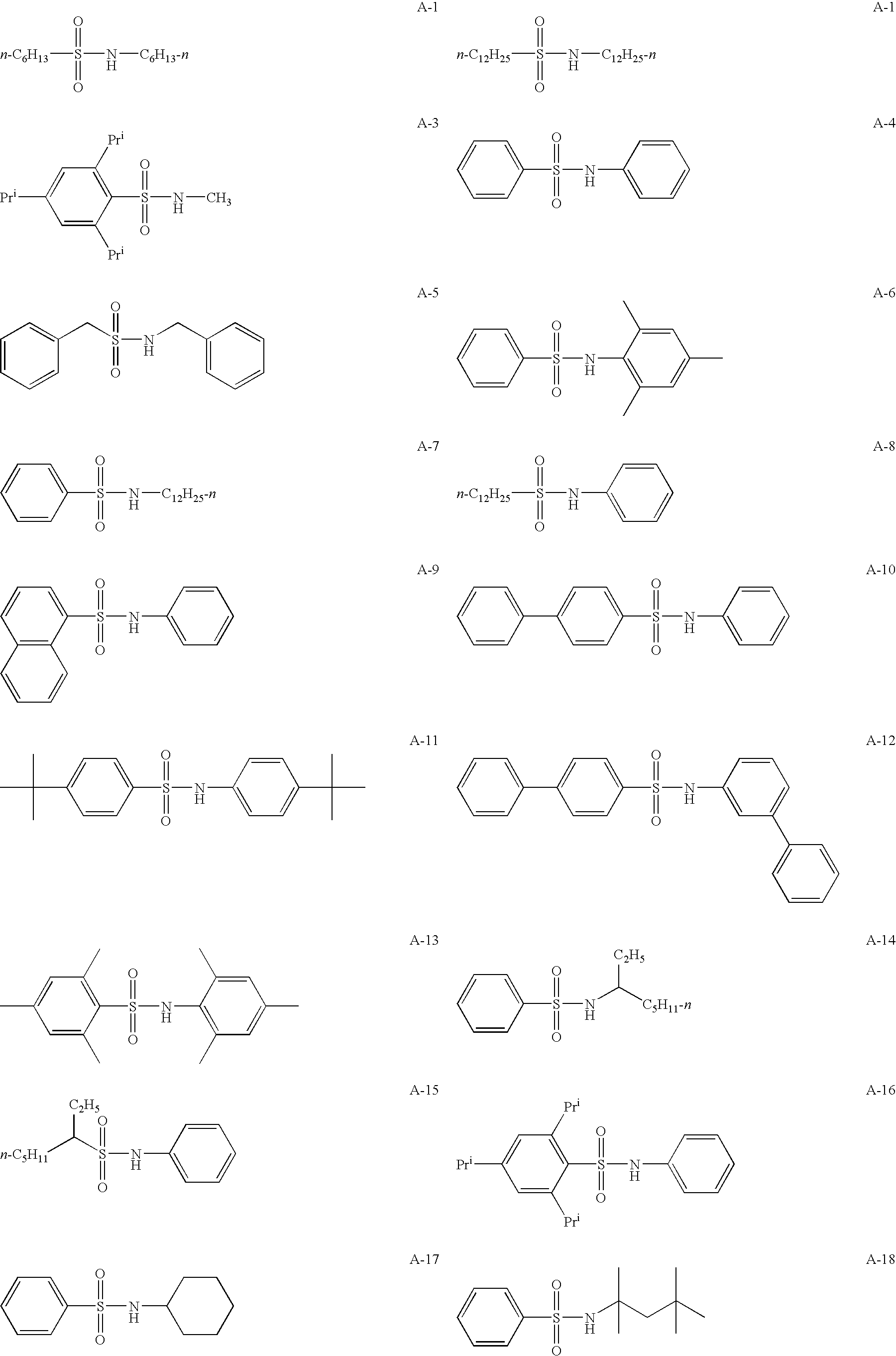

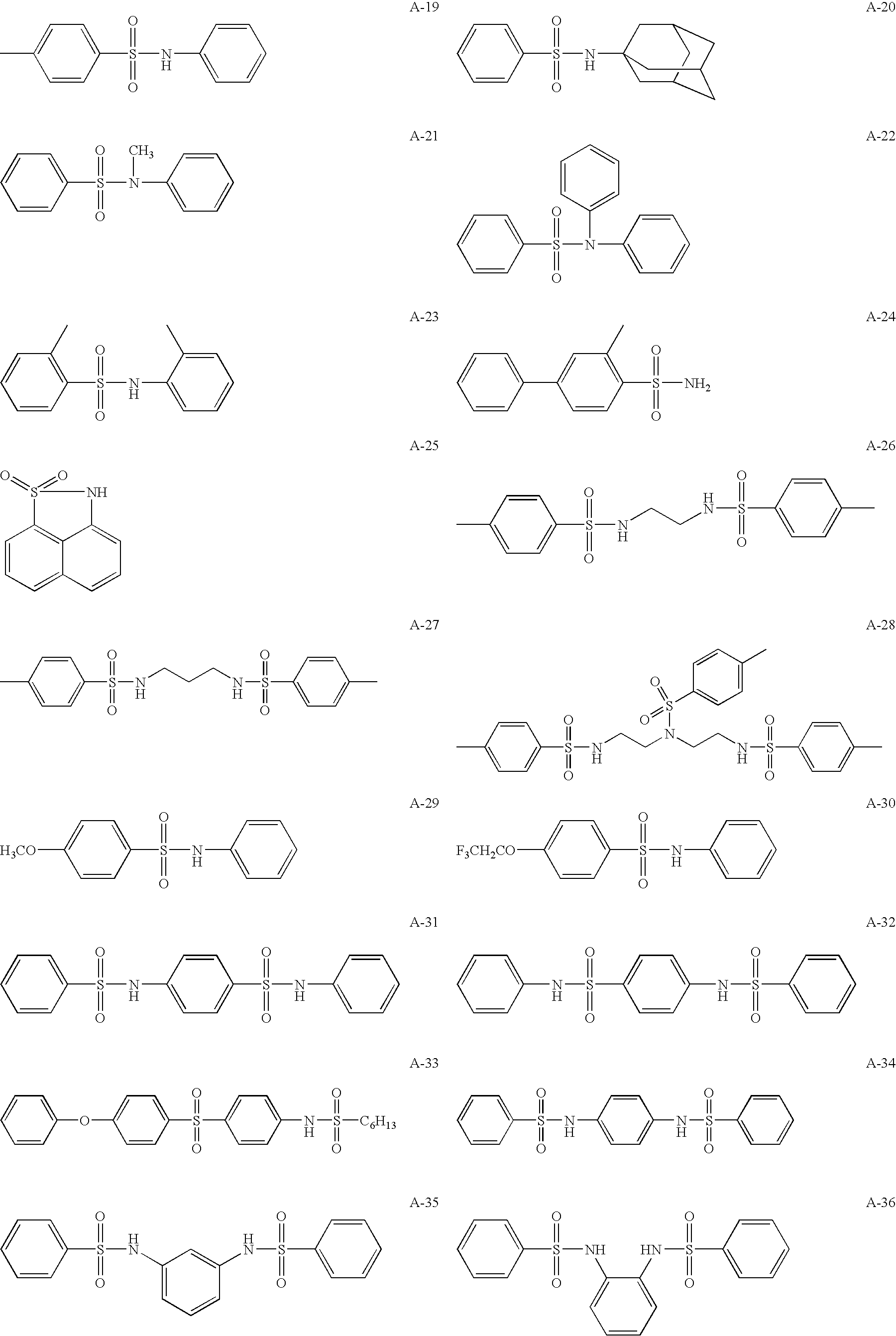

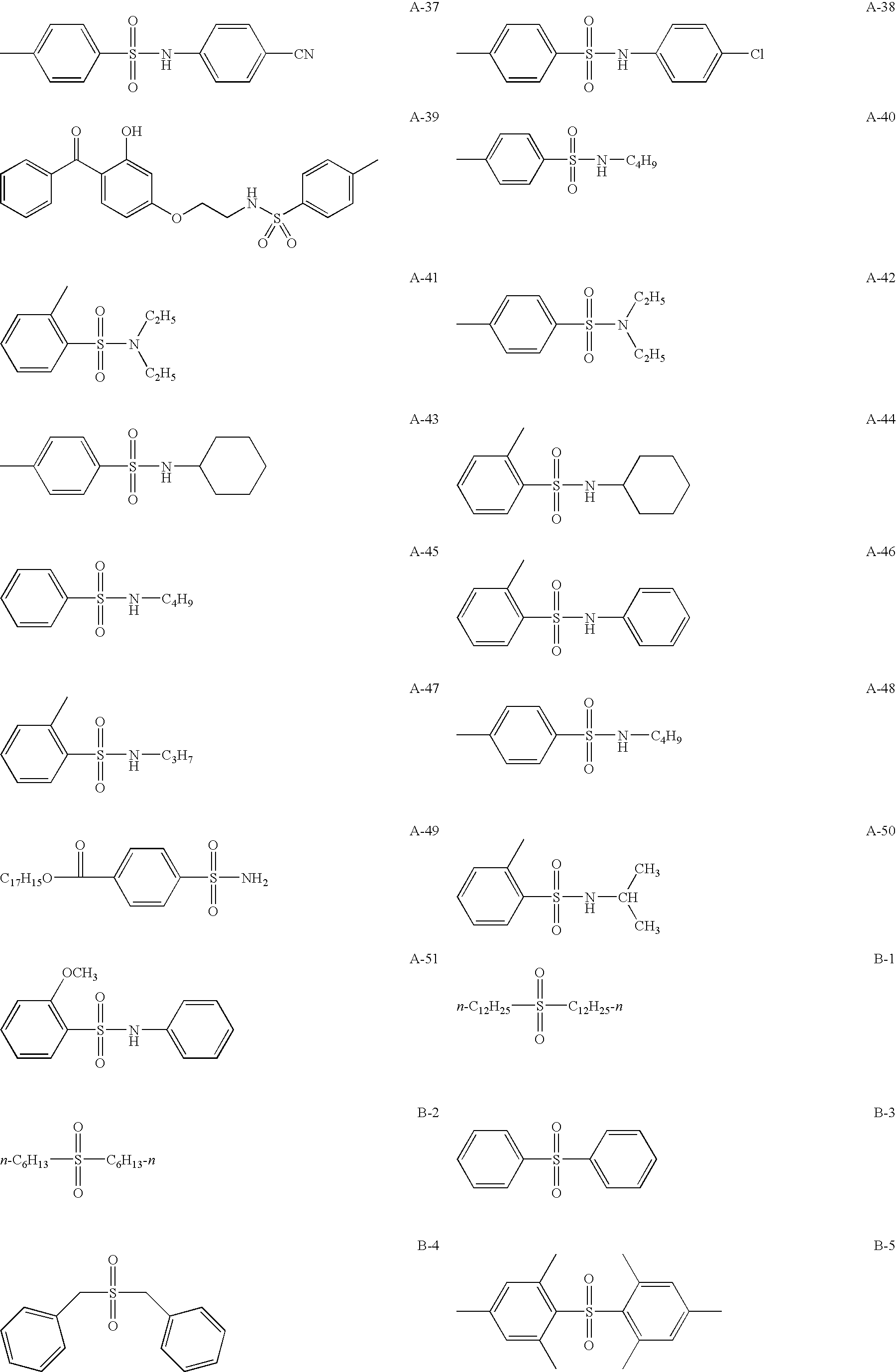

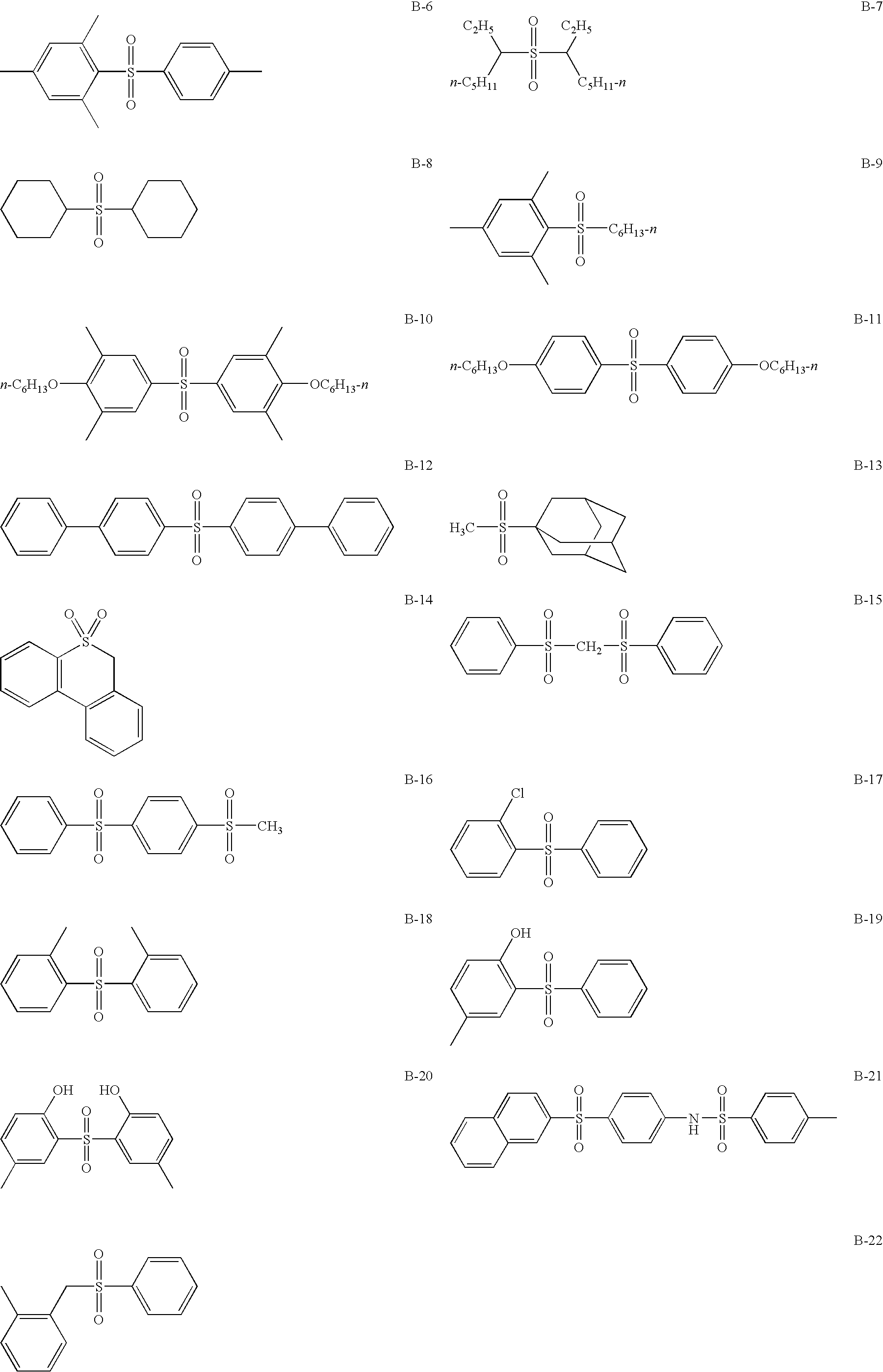

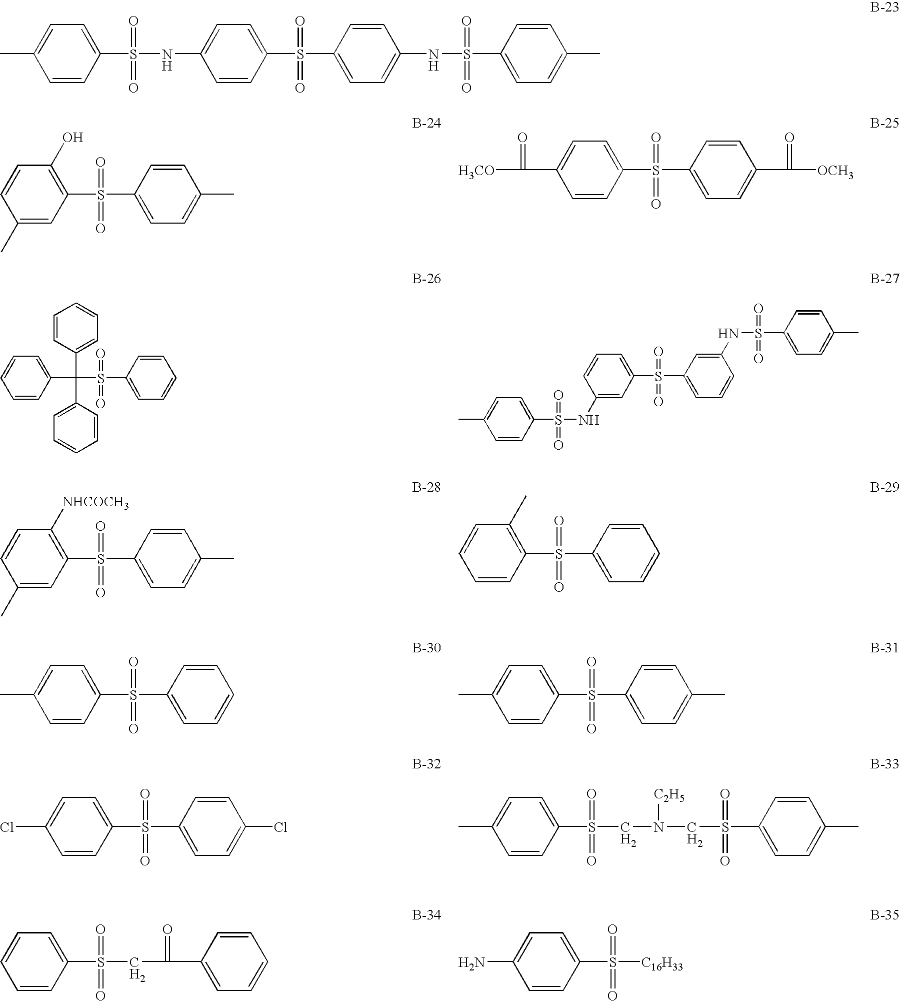

The compounds of formula (IV), which are preferred retardation decreasing agents, can be prepared by condensation reaction between a sulfonyl chloride derivative and an amine derivative. The compounds of formula (V), another group of preferred retardation decreasing agents, are prepared by oxidation reaction of a sulfide compound or Friedel-Crafts reaction between an aromatic compound and sulfonyl chloride.

The compound represented by the formula (IV) or (V) can be added in an amount preferably of 0.01% to 30% by weight, more preferably 0.1% to 20% by weight, even more preferably 0.2% to 10% by weight, based on the cyclic polyolefin resin. Addition of more than 30% by weight of the retardation decreasing agent tends to cause trouble in mixing with the matrix cyclic polyolefin resin and can result in whitening in part or the entire area of the film.

When two or more compounds are added in combination, it is preferred that their total amount be in the recited range.

Next, the compound represented by formula (VI) will be described in greater detail.

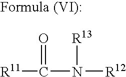

In the formula (VI), R¹¹ represents an aryl group; R¹² and R¹³ each independently represent an alkyl group or an aryl group, provided that at least one of R¹² and R¹³ is an aryl group. In the case where R¹² is an aryl group, R¹³ may be either an alkyl group or an aryl group, though an alkyl group is preferred. The alkyl group may be straight, branched or cyclic. The alkyl group preferably contains 1 to 20 carbon atoms, more preferably 1 to 15 carbon atoms, even more preferably 1 to 12 carbon atoms. The aryl group preferably contains 6 to 36 carbon atoms, more preferably 6 to 24 carbon atoms.

Next, the compound represented by formula (VII) will be described in greater detail.

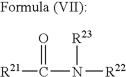

In the formula (VII), R²¹, R²² and R²³ each independently represent an alkyl group. The alkyl group may be straight, branched or cyclic. It is preferable that R²¹ is a cyclic alkyl group and it is more preferable that at least one of R²² and R²³ is a cyclic alkyl group. The alkyl group preferably contains 1 to 20 carbon atoms, more preferably 1 to 15 carbon atoms, even more preferably 1 to 12 carbon atoms. As the cyclic alkyl group, a cyclohexyl group is particularly preferred.

The alkyl and aryl groups in the formulae (VI) and (VII) may each have a substituent. Preferable examples of the substituent include a halogen atom (for example, chlorine, bromine, fluorine and iodine), an alkyl group, an aryl group, an alkoxy group, an aryloxy group, an acyl group, an alkoxycarbonyl group, an aryloxycarbonyl group, an acyloxy group, a sulfonylamino group, a hydroxy group, a cyano group, an amino group and an acylamino group. A halogen atom, an alkyl group, an aryl group, an alkoxy group, an aryloxy group, a sulfonylamino group and an acylamino group are more preferable, and an alkyl group, an aryl group, a sulfonylamino group and an acylamino group are even more preferable.

Preferable examples of the compounds represented by the formulae (VI) and (VII) are as follows, though the present invention is not restricted thereto.

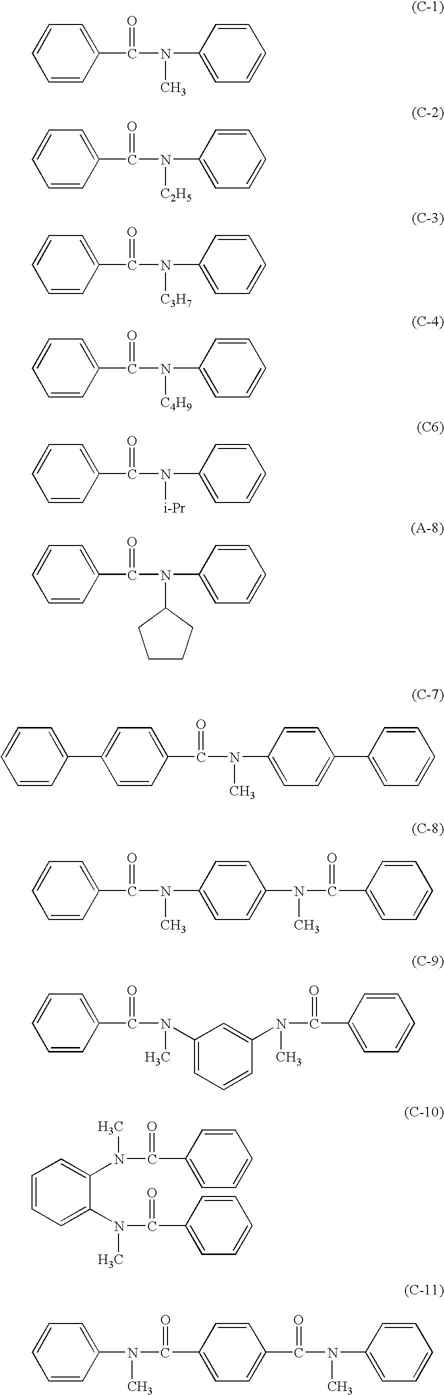

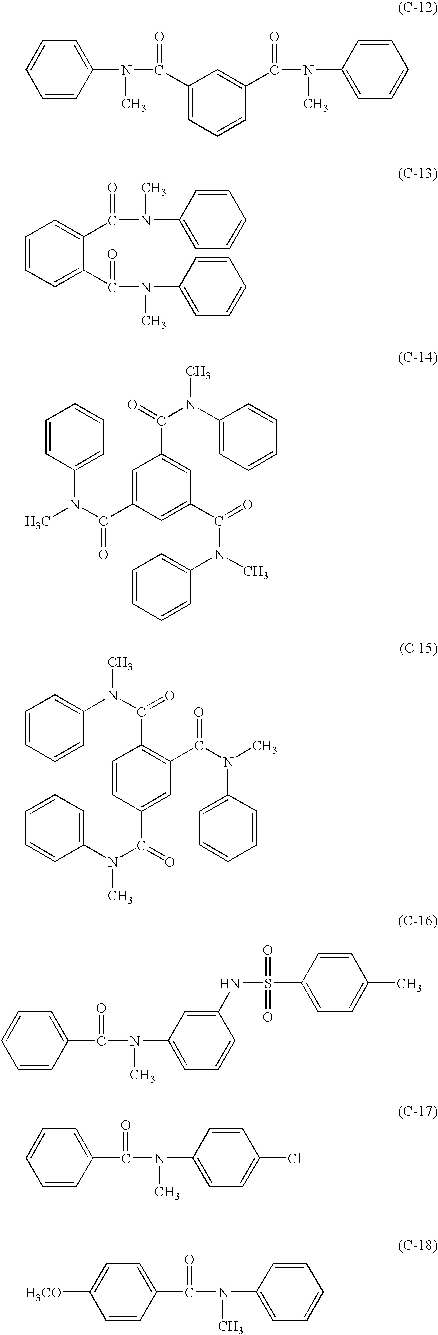

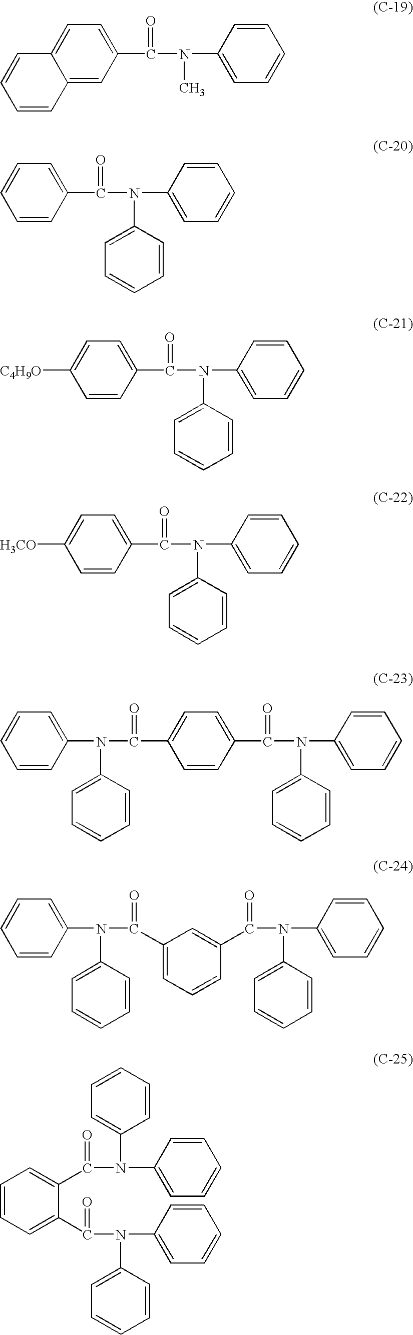

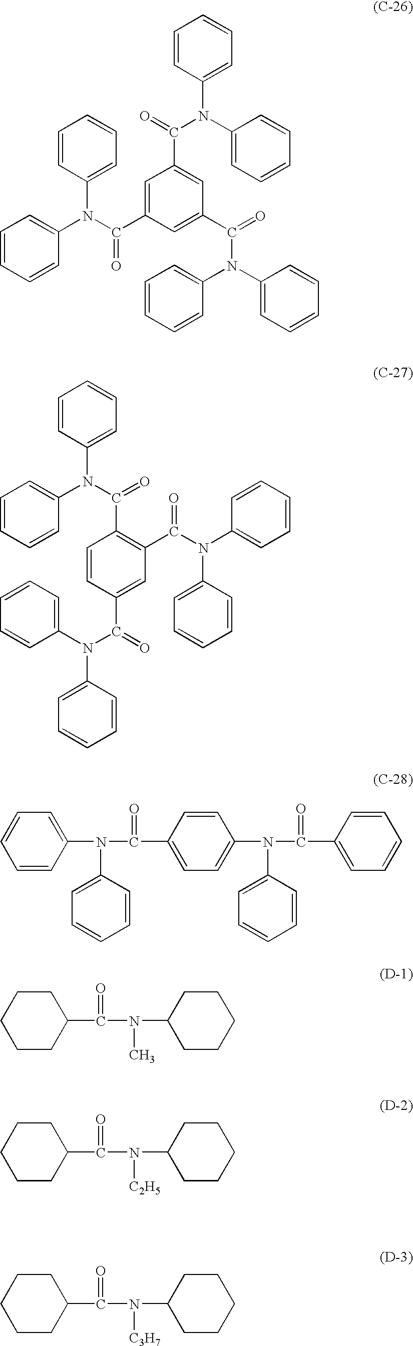

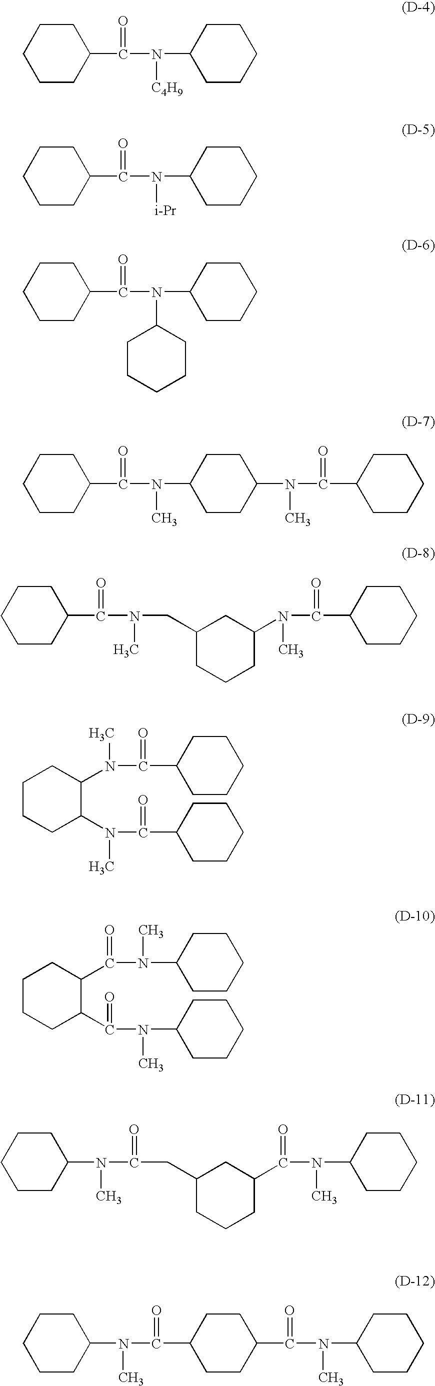

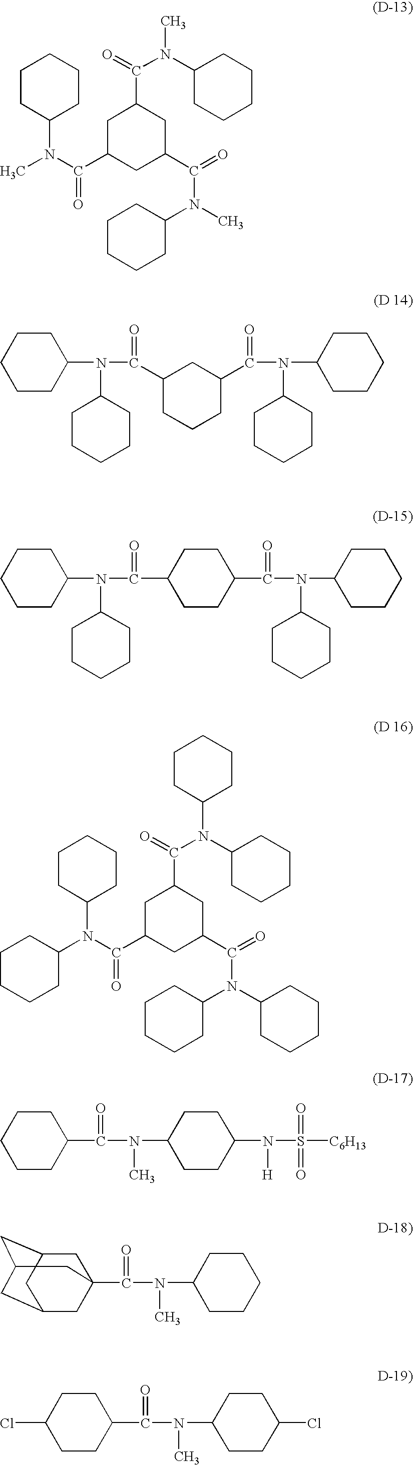

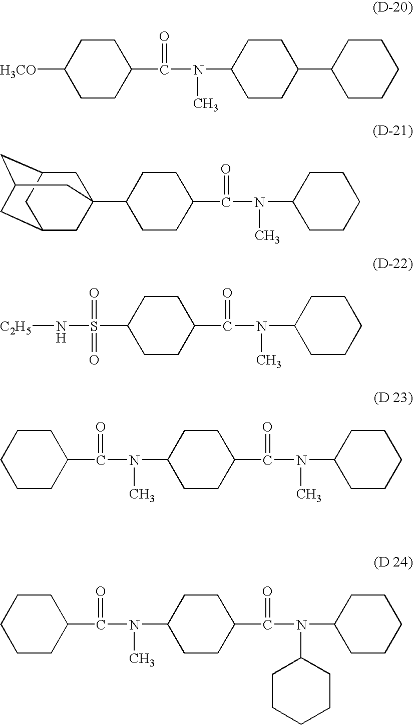

Next, the compound represented by the formula (VIII) will be described.

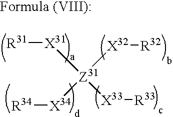

In the formula (VIII), R³¹, R³², R³³, R³⁴ each independently represent a hydrogen atom, a substituted or unsubstituted aliphatic group or a substituted or unsubstituted aromatic group. An aliphatic group is preferable. The aliphatic group may be straight, branched or cyclic and a cyclic aliphatic group is preferable. As an example of the substituent which the aliphatic group and the aromatic group may have, the substituent T as will be described, though an unsubstituted group is preferred.

X³¹, X³², X³³, and X³⁴ each independently represent a single bond or a divalent linking group composed of at least one group selected from among —CO— and NR³⁵— (wherein R³⁵ represents a substituted or unsubstituted aliphatic group or a substituted or unsubstituted aromatic group and an unsubstituted group and/or an aliphatic group is more preferable). Although the combination of X³¹, X³², X³³, and X³⁴ is not particularly restricted, it is preferable that they are selected from among —CO— and NR³⁵—. a, b, c, and d are each an integer of 0 or greater, and 0 or 1 is preferable. a+b+c+d is 2 or greater, preferably 2 to 8, more preferably 2 to 6 and even more preferably 2 to 4. Z³¹ represents an organic group (excluding a cyclic one) having a valence of (a+b+c+d). The valence of Z³¹ is preferably 2 to 8, more preferably 2 to 6, even more preferably 2 to 4 and most preferably 2 or 3. The term “organic group” means a group composed of an organic compound.

Concerning the formula (VIII), a compound represented by the following formula (VIII-1) is preferable.
R³¹¹—X³¹¹-Z³¹¹-X³¹²—R³¹² Formula (VIII-1)

In the formula (VIII-1), R³¹¹ and R³¹² each independently represent a substituted or unsubstituted aliphatic group or a substituted or unsubstituted aromatic group. An aliphatic group is preferable. The aliphatic group may be straight, branched or cyclic and a cyclic aliphatic group is preferable. As an example of the substituent which the aliphatic group and the aromatic group may have, the substituent T as will be described, though an unsubstituted group is preferred. X³¹¹ and X³¹² each independently represent —CONR³¹³— or —NR³¹⁴CO—. R³¹³ and R³¹⁴ each independently represent a substituted or unsubstituted aliphatic group or a substituted or unsubstituted aromatic group and an unsubstituted group and/or an aliphatic group are preferred. Z³¹¹ represents a divalent organic group (excluding a cyclic one) composed of one or more groups selected from —O—, —S—, —SO—, —SO₂—, —CO—, —NR³¹⁵— (wherein R³¹⁵ represents a substituted or unsubstituted aliphatic group or a substituted or unsubstituted aromatic group and an unsubstituted group and/or an aliphatic group are preferred), an alkylene group and an arylene group. Although the combination of Z³¹¹ is not particularly restricted, it is preferably selected from among —O—, —S—, —NR³¹⁵— and an alkylene group, more preferably from —O—, —S— and an alkylene group, and most preferably from —O—, —S— and an alkylene group. Concerning the formula (VIII-1), compounds represented by the following formulae (VIII-2) to (VIII-4) are preferable.

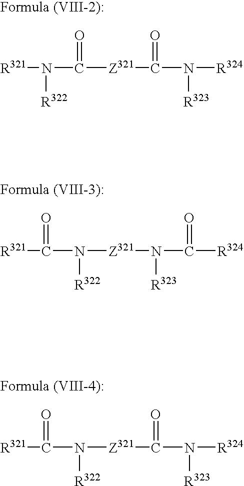

In the formulae (VIII-2) to (VIII-4), R³²¹, R³²², R³²³ and R³²⁴ each independently represent a substituted or unsubstituted aliphatic group or a substituted or unsubstituted aromatic group. An aliphatic group is preferable. The aliphatic group may be straight, branched or cyclic and a cyclic aliphatic group is preferable. As an example of the substituent which the aliphatic group and the aromatic group may have, the substituent T as will be described, though an unsubstituted group is preferred. Z³²¹ represents a divalent organic group composed of one or more groups selected from —O—, —S—, —SO—, —SO₂—, —CO—, —NR³²⁵— (wherein R³²⁵ represents a substituted or unsubstituted aliphatic group or a substituted or unsubstituted aromatic group and an unsubstituted group and/or an aliphatic group are preferred), an alkylene group and an arylene group. Although the combination of Z³²¹ is not particularly restricted, it is preferably selected from among —O—, —S—, —NR³²⁵— and an alkylene group, more preferably from —O—, —S— and an alkylene group, and most preferably from —O—, —S— and an alkylene group.

Next, the substituted or unsubstituted aliphatic group as described above will be illustrated.

The aliphatic group may be straight, branched or cyclic and a cyclic aliphatic group is preferable. It preferably has 1 to 25 carbon atoms, more preferably 6 to 25 carbon atoms and even more preferably 6 to 20 carbon atoms. Specific examples of the aliphatic group include a methyl group, an ethyl group, an n-propyl group, an isopropyl group, a cyclopropyl group, an n-butyl group, an isobutyl group, a t-butyl group, an amyl group, an isoamyl group, a t-amyl group, an n-hexyl group, a cyclohexyl group, an n-heptyl group, an n-octyl group, a bicyclooctyl group, an and a mantyl group, an n-decyl group, a t-octyl group, a dodecyl group, a hexadecyl group, an octadecyl group, a didecyl group and so on.

Next, the aromatic group as described above will be illustrated.

The aromatic group may be either an aromatic hydrocarbon group or an aromatic heterocyclic group and an aromatic hydrocarbon group is preferred. The aromatic hydrocarbon group preferably has 6 to 24 carbon atoms, more preferably 6 to 12 carbon atoms. Specific examples of the aromatic hydrocarbon group include benzene, naphthalene, anthracene, biphenyl, terphenyl and so on. As the aromatic hydrocarbon group, benzene, naphthalene or biphenyl is particularly preferable. The aromatic heterocyclic group preferably contains at least one of an oxygen atom, a nitrogen atom and a sulfur atom. Specific examples of the heterocycle include furan, pyrrole, thiophene, imidazole, pyrazole, pyridine, pyrazine, pyridazine, triazole, triazine, indole, indazole, purine, thiazoline, thiadiazole, oxazoline, oxazole, oxadiazole, quinoline, isoquinoline, phthalazine, naphthylizine, quinoxaline, quinazoline, cinnoline, pteridine, acridine, phenanthoroline, phenazine, tetrazole, benzimidazole, benzoxazole, benzthiazole, benztriazole, tetrazaindene and so on. As the aromatic heterocyclic group, pyridine, triazine or quinoline are particularly preferred.

Next, the substituent T as described above will be described in greater detail.

Examples of the substituent T include an alkyl group (preferably having from 1 to 20 carbon atoms, more preferably from 1 to 12 carbon atoms, and even more preferably from 1 to 8 carbon atoms; for example, a methyl group, an ethyl group, an isopropyl group, a t-butyl group, an n-octyl group, an n-decyl group, an n-hexadecyl group, a cyclopropyl group, a cyclopentyl group and a cyclohexyl group), an alkenyl group (preferably having from 2 to 20 carbon atoms, more preferably from 2 to 12 carbon atoms, and even more preferably from 2 to 8 carbon atoms; for example, a vinyl group, an allyl group, a 2-butenyl group, and a 3-pentenyl group), an alkynyl group (preferably having from 2 to 20 carbon atoms, more preferably from 2 to 12 carbon atoms, and even more preferably from 2 to 8 carbon atoms; for example, a propargyl group and a 3-pentenyl group), an aryl group (preferably having from 6 to 30 carbon atoms, more preferably from 6 to 20 carbon atoms, and even more preferably from 6 to 12 carbon atoms; for example, a phenyl group, a biphenyl group and a naphthyl group), an amino group (preferably having from 0 to 20 carbon atoms, more preferably from 0 to 10 carbon atoms, and even more preferably from 0 to 6 carbon atoms; for example, an amino group, a methylamino group, a dimethylamino group, a diethylamino group and a dibenzylamino group), an alkoxy group (preferably having from 1 to 20 carbon atoms, more preferably from 1 to 12 carbon atoms, and even more preferably from 1 to 8 carbon atoms; for example, a methoxy group, an ethoxy group and a butoxy group), an aryloxy group (preferably having from 6 to 20 carbon atoms, more preferably from 6 to 16 carbon atoms, and especially from 6 to 12 carbon atoms; for example, a phenyloxy group and a 2-naphthyloxy group), an acyl group (preferably having from 1 to 20 carbon atoms, more preferably from 1 to 16 carbon atoms, and even more preferably from 1 to 12 carbon atoms; for example, an acetyl group, a benzoyl group, a formyl group, and a pivaloyl group), an alkoxy carbonyl group (preferably having from 2 to 20 carbon atoms, more preferably from 2 to 16 carbon atoms, and especially preferably from 2 to 12 carbon atoms; for example, a methoxycarbonyl group and an ethoxycarbonyl group), an aryloxycarbonyl group (preferably having from 7 to 20 carbon atoms, more preferably from 7 to 16 carbon atoms, and even more preferably from 7 to 10 carbon atoms; for example, a phenyloxycarbonyl group), an acyloxy group (preferably having from 2 to 20 carbon atoms, more preferably from 2 to 16 carbon atoms, and even more preferably from 2 to 10 carbon atoms; for example, an acetoxy group and a benzoyloxy group), an acylamino group (preferably having from 2 to 20 carbon atoms, more preferably from 2 to 16 carbon atoms, and even more preferably from 2 to 10 carbon atoms; for example, an acetylamino group and a benzoylamino group), an alkoxycarbonylamino group (preferably having from 2 to 20 carbon atoms, more preferably from 2 to 16 carbon atoms, and even more preferably from 2 to 12 carbon atoms; for example, a methoxycarbonylamino group), an aryloxycarbonylamino group (preferably having from 7 to 20 carbon atoms, more preferably from 7 to 16 carbon atoms, and even more preferably from 7 to 12 carbon atoms; for example, a phenyloxycarbonylamino group), a sulfonylamino group (preferably having from 1 to 20 carbon atoms, more preferably from 1 to 16 carbon atoms, and even more preferably from 1 to 12 carbon atoms; for example, a methanesulfonylamino group and a benzenesulfonylamino group),

a sulfamoyl group (preferably having from 0 to 20 carbon atoms, more preferably from 0 to 16 carbon atoms, and even more preferably from 0 to 12 carbon atoms; for example, a sulfamoyl group, a methylsulfamoyl group, a dimethylsulfamoyl group and a phenylsulfamoyl group), a carbamoyl group (preferably having from 1 to 20 carbon atoms, more preferably from 1 to 16 carbon atoms, and even more preferably from 1 to 12 carbon atoms; for example, a carbamoyl group, a methylcarbamoyl group, a diethylcarbamoyl group and a phenyl carbamoyl group), an alkylthio group (preferably having from 1 to 20 carbon atoms, more preferably from 1 to 16 carbon atoms, and even more preferably from 1 to 12 carbon atoms; for example, a methylthio group and an ethylthio group), an artylthio group (preferably having from 6 to 20 carbon atoms, more preferably from 6 to 16 carbon atoms, and even more preferably from 6 to 12 carbon atoms; for example, a phenylthio group), a sulfonyl group (preferably having from 1 to 20 carbon atoms, more preferably from 1 to 16 carbon atoms, and even more preferably from 1 to 12 carbon atoms; for example, a mesyl group and a tosyl group), a sulfinyl group (preferably having from 1 to 20 carbon atoms, more preferably from 1 to 16 carbon atoms, and even more preferably from 1 to 12 carbon atoms; for example, a methanesulfinyl group and a benzene sulfinyl group), a ureido group (preferably having from 1 to 20 carbon atoms, more preferably from 1 to 16 carbon atoms, and even more preferably from 1 to 12 carbon atoms; for example, a ureido group, a methylureido group and a phenylureido group), a phosphoric acid amide group (preferably having from 1 to 20 carbon atoms, more preferably from 1 to 16 carbon atoms, and even more preferably from 1 to 12 carbon atoms; for example, a diethylphosphoric acid amide group and a phenylphosphoric acid amide group), a hydroxyl group, a mercapto group, a halogen atom (for example, a fluorine atom, a chlorine atom, a bromine atom and an iodine atom), a cyano group, a sulfo group, a carboxyl group, a nitro group, a hydroxamic acid group, a sulfino group, a hydrazino group, an imino group, a heterocyclic group (preferably having from 1 to 30 carbon atoms, and more preferably from 1 to 12 carbon atoms; examples of the hetero atom include a nitrogen atom, an oxygen atom, and a sulfur atom; and specific examples of the heterocyclic group include an imidazolyl group, a pyridyl group, a quinolyl group, a furyl group, a piperidyl group, a morpholino group, a benzoxazolyl group, a benzimidazolyl group and a benzthiazolyl group), and a silyl group (preferably having from 3 to 40 carbon atoms, more preferably from 3 to 30 carbon atoms, and even more preferably from 3 to 24 carbon atoms; for example, a trimethylsilyl group and a triphenylsilyl group). These substituents may be further substituted. Furthermore, when two or more substituents are present, these substituents may be the same or different. Moreover, if possible, the substituents may be taken together to form a ring.

Specific examples of the compound represented by the formula (VIII) will be given below, but it should be construed that the invention is not limited to these specific examples at all.

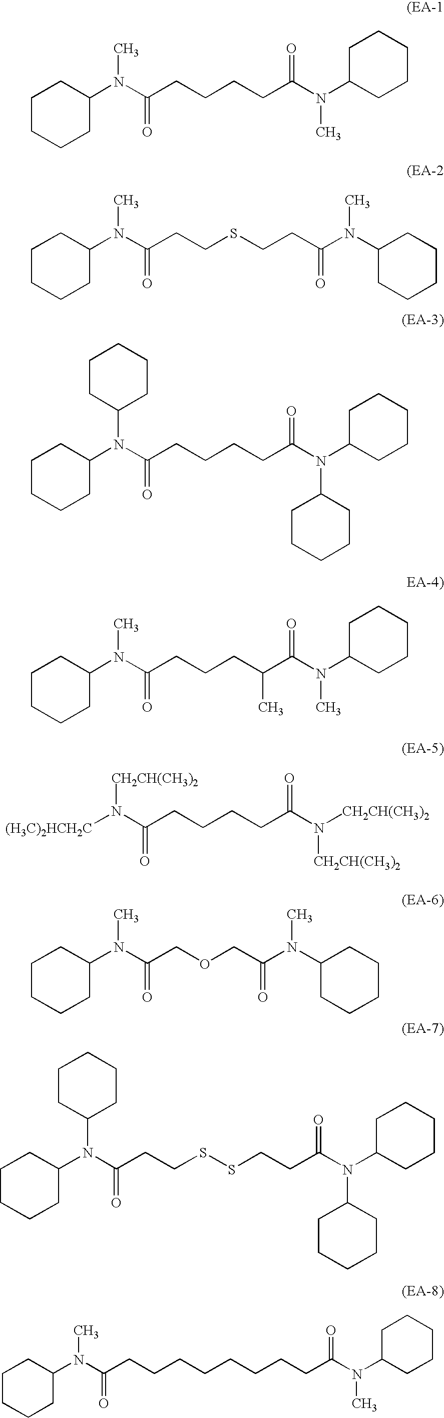

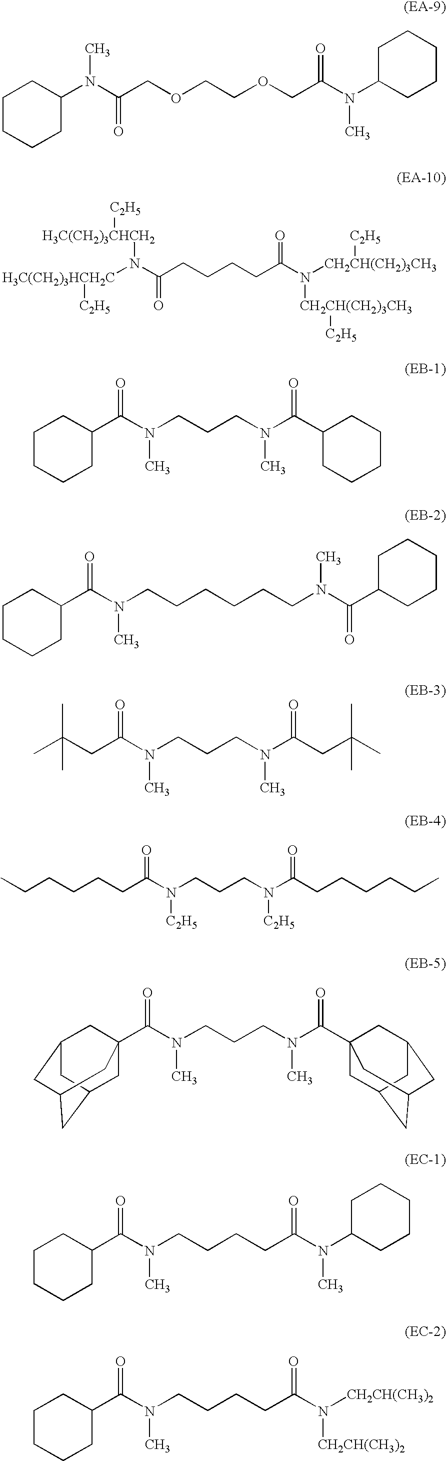

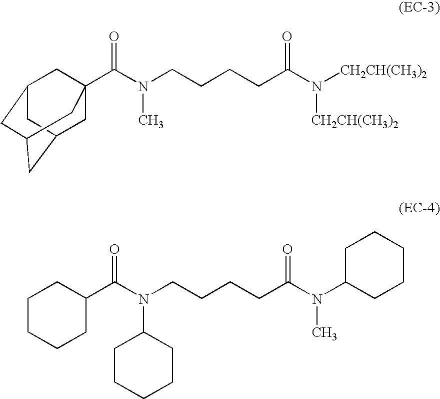

The compounds of the formulae (VI), (VII) and (VIII) can be obtained by the dehydration condensation of a carboxylic acid with an amine with the use of, for example, a condensation agent such as dicyclohexylcarbodiimide (DCC), the substitution between a carboxylic acid chloride derivative and an amine derivative or the like.

The above described Rth decreasing agent and Re decreasing agent preferably employed in the present invention can be added in an amount preferably of 0.01% to 30% by weight, more preferably 0.1% to 20% by weight, even more preferably 0.2% to 10% by weight, based on the cyclic polyolefin resin.

Addition of more than 30% by weight of the above-described decreasing agent tends to cause trouble in mixing with the matrix cyclic polyolefin resin and can result in whitening in part or the entire area of the film.

When two or more compounds are added in combination, it is preferred that their total amount is 0.01% to 30% by weight, more preferably 0.1% to 20% by weight, even more preferably 0.2% to 10% by weight, based on the cyclic polyolefin resin.

Next, the compound having the structure represented by the formula (IX) or (X) will be described.

The formula (IX) indicates a structural unit obtained from an aromatic vinyl monomer. Specific examples of the aromatic vinyl monomer include styrene; an alkylated styrene such as such as α-methylstyrene, β-methylstyrene and p-methylstyrene; a halogenated styrene such as 4-chlorostyrene and 4-bromostyrene; a hydroxystyrene such as p-hydroxystyrene, α-methyl-p-hydroxystyrene, 2-methyl-4-hydroxystyrene and 3,4-dihydroxystyrene; a vinylbenzyl alcohol; an alkoxylated styrene such as p-methoxystyrene, p-t-butoxystyrene and m-t-butoxystyrene; a vinylbenzoic acid such as 3-vinylbenzoic acid and 4-vinylbenzoic acid; a vinylbenzic acid ester such as methyl-4-vinylbenzoate and ethyl-4-vinylbenzoate; 4-vinylbenzyl acetate; 4-acetoxystyrene; an amidostyrene such as 2-butyl amidostyrene, 4-methyl amidostyrene and p-sulfonamidostyrene; an aminostyrene such as 3-aminostyrene, 4-aminostyrene, 2-isopropenylaniline and vinylbenzyldimethylamine; a nitrostyrene such as 3-nitrostyrene and 4-nitrostyrene; a cyanostyrene such as 3-cyanostyrene and 4-cyanostyrene; vinylphenyl acetonitrile; an arylstyrene such as phenylstyrene; an indene and so on, though the present invention is not restricted to these specific examples. Two or more these monomers may be employed as copolymerizable components. Among these aromatic vinyl monomers, styrene and α-methylstyrene are preferable since they are easily available on an industrial scale and less expensive.

The formula (X) indicates a structural unit obtained from an acrylic acid ester monomer. Specific examples of the acrylic acid ester monomer include methyl acrylate, ethyl acrylate, (i- or n-)propyl acrylate, (n-, i-, s- or t-)butyl acrylate, (n-, i- or s-)pentyl acrylate, (n- or i-)hexyl acrylate, (n- or i-)heptyl acrylate, (n- or i-)octyl acrylate, (n- or i-)nonyl acrylate, (n- or i-)myrystyl acrylate, (2-ethylhexyl)acrylate, (ε-caprolactone) acrylate, (2-hydroxyethyl)acrylate, (2-hydroxypropyl)acrylate, (3-hydroxypropyl)acrylate, (4-hydroxybutyl)acrylate, (2-hydroxybutyl)acrylate, (2-methoxyethyl)acrylate, (2-ethoxyethyl)acrylate, phenyl acrylate, phenylmethacrylate, (2- or 4-chlorophenyl)acrylate, (2- or 4-chlorophenyl)methacrylate, (2-, 3- or 4-ethoxycarbonylphenyl)acrylate, (2-, 3- or 4-ethoxycarbonylphenyl)methacrylate, (o-, m- or p-tolyl)acrylate, (o-, m- or p-tolyl)methacrylate, benzyl acrylate, benzyl methacrylate, phenethyl acrylate, phenethyl methacrylate, (2-naphthyl)acrylate, cyclohexyl acrylate, cyclohexyl methacrylate, (4-methylcyclohexyl)acrylate, (4-methylcyclohexyl)methacrylate, (4-ethylcyclohexyl)acrylate, (4-ethylcyclohexyl)methacrylate and so on as well as those wherein the acrylate as described above has been converted into methacrylate, though the present invention is not restricted to these specific examples. Two or more these monomers may be employed as copolymerizable components. Among these acrylic acid ester monomers, methyl acrylate, ethyl acrylate, (i- or n-)propyl acrylate, (n-, i-, s- or t-)butyl acrylate, (n-, i-ors-)pentyl acrylate, (n- or i-)hexyl acrylate or those wherein the acrylate as described above has been converted into methacrylate are preferable since they are easily available on an industrial scale and less expensive.

It is preferable that the (co)polymer as described above contains at least one structural unit obtained from the aromatic vinyl monomer represented by the formula (IX) and the acrylic acid ester monomer represented by the formula (X). As another component constituting the copolymer composition, those highly copolymerizable with the above-described monomers are preferred. Examples thereof include an anhydride such as maleic anhydride, citraconic anhydride, cis-1-cyclohexene-1,2-dicarboxylic anhydride, 3-methyl-cis-1-cyclohexane-1,2-dicarboxylic anhydride and 4-methyl-cis-1-cyclohexane-1,2-dicarboxylic anhydride; a nitrile-containing radical polymerizable monomer such as acrylonitrile and methacrylonitrile; an amide bond-containing radical polymerizable monomer such as acrylamide, methacrylamide and trifluoromethanesulfonylaminoethyl(meth)acrylate; a fatty acid vinyl such as vinyl acetate; a chlorinated radical polymerizable monomer such as vinyl chloride and vinylidene chloride; a conjugated diolefin such as 1,3-butadiene, isoprene and 1,4-dimethylbutadiene and so on, though the present invention is not restricted thereto.

In the case of using such a copolymer as described above, it is preferable that the content of the group represented by the formula (IX) is at least 30% by mol on the basis of the copolymer composition. It is also preferable that the content of the group represented by the formula (X) is at least 20% by mol. It is also preferable that the ratio of another copolymerizable component is not more than 50% by mol.

By adding at least one compound having the structure represented by the formula (IX) or (X) to the cyclic polyolefin, the retardation in the thickness direction Rth can be decreased and the desired optical characteristics can be established during the film formation.

The expression “to decrease Rth of cyclic polyolefin film” as used herein means that the Rth (nm; in terms of a film thickness of 80 μm) of a film containing A % of a compound having the structure represented by the formula (IX) or (X) is smaller by 10 nm or more than the Rth (nm; in terms of a film thickness of 80 μm) of a film free from a compound having the structure represented by the formula (IX) or (X).

In the present invention, the ability to decrease Rth of a cyclic polyolefin film can be expressed by (Rth(A)−Rth(0))/A.

It is preferable that the cyclic polyolefin film according to the present invention satisfies the following conditions (1) and (2).
Rth(A)−Rth(0)≦−10 Condition (1)

To obtain the desired optical characteristics, the film satisfies preferably:
Rth(A)−Rth(0)≦−30 Condition (1-2)
most preferably:
Rth(A)−Rth(0)≦−50. Condition (1-3)
(Rth(A)−Rth(0))/A≦−1.0 Condition (2)

To broaden the regulation range of the optical characteristics, the film satisfies preferably:
(Rth(A)−Rth(0))/A≦−3.0 Condition (2-2)
most preferably:
(Rth(A)−Rth(0))/A≦−5.0. Condition (2-3)

In the above conditions (1), (1-2), (1-3), (2), (2-2) and (2-3):

Rth(A) is the Rth (nm; in terms of a film thickness of 80 μm) of a film containing A % of a compound having the structure represented by the formula (IX) or (X);

Rth(0) is the Rth (nm; in terms of a film thickness of 80 μm) of a film free from a compound having the structure represented by the formula (IX) or (X); and

A is the weight (%) of a compound having the structure represented by the formula (IX) or (X) on the basis of the weight of the cyclic polyolefin as described above.

The weight-average molecular weight of the compound having the structure represented by the formula (IX) or (X) is preferably 500 or more but not more than 300000, more preferably 500 or more but not more than 15000 from the viewpoints of the compatibility with the binder and obtaining a film having a high transparency and showing favorable optical characteristics after the film formation, and even more preferably 500 or more but not more than 5000.

In the present invention, the weight-average molecular weight of a compound to be added to the cyclic polyolefin is polystyrene equivalent weight average molecular weight measured by GPC (developed in tetrahydrofuran).

The content of the above-described compound having the structure represented by the formula (IX) or (X) that is preferably used in the present invention is preferably 0.1 to 40% by weight on the basis of the cyclic polyolefin resin, more preferably 1 to 30% by weight from the viewpoint of obtaining a film having a high transparency and showing favorable optical characteristics after the film formation, and even more preferably 3 to 20% by weight.

Either a single compound having the structure represented by the formula (IX) or (X) or two or more thereof mixed at an arbitrary ratio may be used.

The total content of two or more compounds having the structure represented by the formula (IX) or (X) is preferably 0.1 to 40% by weight on the basis of the cyclic polyolefin resin, more preferably 1 to 30% by weight from the viewpoint of obtaining a film having a high transparency and showing favorable optical characteristics after the film formation, and even more preferably 3 to 20% by weight.

Next, the polyester polymer will be described.

As the polyester resin to be used as “polyester polymer” in the present invention, there can be enumerated those prepared by a condensation reaction starting with a dicarboxylic acid (or an ester-forming derivative thereof) with a diol (or an ester-forming derivative thereof) and/or a hydroxycarboxylic acid (or an ester-forming derivative thereof).

Examples of the dicarboxylic acid as described above include an aromatic dicarboxylic acid such as terephthalic acid, isophthalic acid, phthalic acid, 2,6-naphthalenedicarboxylic acid, bis(p-carboxyphenyl)methane, anthracenedicarboxylic acid, 4,4′-diphenyl ether dicarboxylic acid, 4,4′-biphenyldicarboxylic acid and 5-sodium sulfoisophthalic acid, an aliphatic dicarboxylic acid such as adipic acid, sebacic acid, azelaic acid and dodecanedionic acid, an alicyclic dicarboxylic acid such as 1,3-cyclohexanedicarboxylic acid and ester-forming derivatives thereof. Two or more kinds of dicarboxylic acids may be used.

Examples of the diol include an aliphatic diol having 2 to 20 carbon atoms such as ethylene glycol, trimethylene glycol, 1,4-butanediol, neopentyl glycol, 1,5-pentanediol, 1,6-hexanediol, decamethylene glycol, cyclohexane dimethanol and cyclohexanediol, a long-chain glycol having a molecular weight of 400 to 6000 such as polyethylene glycol, polytrimethylene glycol and polytetramethylene glycol and ester-forming derivatives thereof. Two or more kinds of diols may be used.

Examples of the above-described polymer or copolymer include polybutylene terephthalate, polybutylene (terephthalate/isophthalate), polybutylene (terephthalate/adipate), polytrimethylene terephthalate, polypropylene (terephthalate/isophthalate), polyethylene terephthalate, polyethylene (terephthalate/isophthalate), polyethylene (terephthalate/adipate), bisphenol A (terephthalate/isophthalate), polybutylene naphthalate, polybutylene (terephthalate/isophthalate), polypropylene naphthalate, polyethylene naphthalate, polycyclohexane dimethylene terephthalate, polycyclohexane dimethylene (terephthalate/isophthalate), poly(cyclohexane dimethylene/ethylene) terephthalate, poly(cyclohexane dimethylene/ethylene) (terephthalate/isophthalate) and so on.

Furthermore, use can be made of a thermoplastic polyester resin which consists of a structural unit selected form among an aromatic oxycarbonyl unit, an aromatic dioxy unit, an aromatic dicarbonyl unit, an ethylenedioxy unit or the like and shows thermotropic liquid crystal properties.

Examples of the aromatic oxycarbonyl unit as used herein include structural units derived from p-hydroxybenzoic acid, 6-hydroxy-2-naphthoic acid or 4′-hydroxydiphenyl-4-carboxylic acid. Examples of the aromatic dioxy unit include structural units derived from 4,4′-dihydroxybiphenyl, hydroquinone or t-butylhydroquinone. Examples of the aromatic dicarbonyl unit include structural units derived from terephthalic acid, isophthalic acid or 2,6-naphthalenecdicarboxylic acid. Examples of the aromatic iminooxy unit include a structural unit derived from 4-aminophenol. As specific examples thereof, there can be enumerated thermotropic liquid crystal polyesters such as p-oxybenzoic acid/polyethylene terephthalate and p-oxybenzoic acid/6-oxy-2-naphthoic acid.

By adding at least one polyester polymer to the cyclic polyolefin, the retardation in the thickness direction Rth can be decreased and the desired optical characteristics can be established during the film formation.

The expression “to decrease Rth of cyclic polyolefin film” as used herein means that the Rth (nm; in terms of a film thickness of 80 μm) of a film containing A % of the above-described polyester polymer is smaller by 10 nm or more than the Rth (nm; in terms of a film thickness of 80 μm) of a film free from the polyester polymer.

In the present invention, the ability to decrease Rth of a cyclic polyolefin film can be expressed by (Rth(A)-Rth(0))/A.

It is preferable that the cyclic polyolefin film according to the present invention satisfies the following conditions (1) and (2).
Rth(A)−Rth(0)≦−10 Condition (1)

To obtain the desired optical characteristics, the film satisfies preferably:
Rth(A)−Rth(0)≦−30 Condition (1-2)
most preferably:
Rth(A)−Rth(0)≦−50. Condition (1-3)
(Rth(A)−Rth(0))/A≦−1.0 Condition (2)

To broaden the regulation range of the optical characteristics, the film satisfies preferably:
(Rth(A)−Rth(0))/A≦−3.0 Condition (2-2)
most preferably:
(Rth(A)−Rth(0))/A≦−5.0. Condition (2-3)

In the above conditions (1), (1-2), (1-3), (2), (2-2) and (2-3):

Rth(A) is the Rth (nm; in terms of a film thickness of 80 μm) of a film containing A % of the above-described polyester polymer;

Rth(0) is the Rth (nm; in terms of a film thickness of 80 μm) of a film free from the above-described polyester polymer; and

A is the weight (%) of the above-described polyester polymer on the basis of the weight of the cyclic polyolefin as described above.

The weight-average molecular weight of the polyester polymer is preferably 500 or more but not more than 300000, more preferably 500 or more but not more than 15000 from the viewpoints of the compatibility with the binder and obtaining a film having a high transparency and showing favorable optical characteristics after the film formation, and even more preferably 500 or more but not more than 5000.

In the present invention, the weight-average molecular weight of the polyester polymer to be added to the cyclic polyolefin is polystyrene equivalent weight average molecular weight measured by GPC (developed in tetrahydrofuran).

The content of the above-described polyester polymer is preferably 0.1 to 30% by weight on the basis of the cyclic polyolefin resin, more preferably 1 to 20% by weight from the viewpoint of obtaining a film having a high transparency and showing favorable optical characteristics after the film formation, and even more preferably 5 to 20% by weight.

Either a single polyester polymer or two or more thereof mixed at an arbitrary ratio may be used.

In the case of using two or more polyester polymers, the total content of the polyester polymers is preferably 0.1 to 30% by weight on the basis of the cyclic polyolefin resin, more preferably 1 to 20% by weight from the viewpoint of obtaining a film having a high transparency and showing favorable optical characteristics after the film formation, and even more preferably 5 to 20% by weight.

The compounds may be used either individually or as a mixture of two or more thereof in a desired mixing ratio.

In the case of using an organic compound capable of reducing thickness direction retardation Rth(λ) is incapable of reducing in-plane retardation Re(λ) or, conversely, in the case of using an organic compound capable of reducing Re(λ) is incapable of reducing Rth(λ), it is apparent that the optical film can be designed to have a desirably increased or decreased Re or Rth value by controlling the amount of addition of the respective retardation decreasing agent. In the case where an organic compound capable of reducing Rth(λ) is also capable of reducing Re(λ), or where an organic compound capable of reducing Re(λ) is also capable of reducing Rth(λ), desired Re and Rth values can be obtained by using these retardation decreasing agents in combination in a controlled mixing ratio.

The retardation decreasing agent may be added at any stage in the preparation of a dope or added to a prepared dope.

The cyclic polyolefin resin can contain fine particles to improve film formation stability and processability of the resulting film and reduce optical unevenness of the film ascribed to winding strain. Particles of organic or inorganic compounds can be used.

The inorganic compounds include silicon compounds (e.g., silicon dioxide), titanium oxide, zinc oxide, aluminum oxide, barium oxide, zirconium oxide, strontium oxide, antimony oxide, tin oxide, tin oxide/antimony, calcium carbonate, talc, clay, calcined kaolin, calcined calcium silicate, hydrated calcium silicate, aluminum silicate, magnesium silicate, and calcium phosphate. Of the above-described inorganic compounds, inorganic silicon compounds and metal oxides are preferred. Silicon dioxide is particularly preferred to provide a film with reduced turbidity. Commercially available silicon dioxide particles can be made use of, including AEROSIL R972, R974, R812, 200, 300, R202, OX50, and TT600 (all available from Nippon Aerosil Co., Ltd.). Commercially available zirconium oxide particles, such as AEROSIL R976 and R811 (both from Nippon Aerosil Co., Ltd.), are useful.

Examples of the organic compounds include polytetrafluoroethylene, cellulose acetate, polystyrene, polymethyl methacrylate, polypropyl methacrylate, polymethyl acrylate, polyethylene carbonate, and starch. Pulverized and classified products of these polymer particles are also used. Polymers prepared by suspension polymerization, spherical polymers obtained by spray drying or dispersing are also useful.

To minimize the haze of the resulting film, the average primary particle size of the fine particles is preferably 0.001 to 20 μm, more preferably 0.001 to 10 μm, even more preferably 0.002 to 1 μm, still more preferably 0.005 to 0.5 μm. The average primary particle size of the particles is obtained by observation under a transmission electron microscope. It is advisable that the particles as purchased, which are often agglomerated, be dispersed in a known manner before use preferably to reduce the secondary particle size to 0.2 to 1.5 μm, still preferably 0.3 to 1 μm. The particles are preferably added in an amount of 0.01 to 0.3 parts by weight, more preferably 0.05 to 0.2 parts by weight, even more preferably 0.08 to 0.12 parts by weight, per 100 parts by weight of the cyclic polyolefin resin.

Dispersing the particles is accompanied by increase in haze and decrease in transparency. Therefore, an average particle size is preferably 0.001 to 100 μm, more preferably 0.01 to 10 μm, even more preferably 0.01 to 5 μm.

The content of the fine particles in the cyclic polyolefin film preferably ranges from 0.0001% to 10% by weight, more preferably 0.001% to 5% by weight, even more preferably 0.01% to 3% by weight, irrespective of whether the particles are dispersed as discrete particles (spherical or irregular) or on a molecular level.

The cyclic polyolefin film preferably has a light transmittance of 88.8% or more, more preferably 89.0% or more, even more preferably 90.0% or more. The transmittance was measured on a specimen measuring 13 mm by 40 mm at a wavelength of 550 nm with a spectrophotometer U-3210 from Hitachi, Ltd. at 25° C. and 60% RH.

Methods of incorporating the compound into the film are not particularly limited and include a solvent casting technique using a dope containing the cyclic polyolefin resin and the compound, a method in which a dispersion or solution of the compound is applied to a cast film of the cyclic polyolefin resin, and a multilayer casting technique. In the present invention, the cyclic polyolefin film is preferably produced by either of the following two processes.

Process-I

Process-I includes the steps of dissolving or dispersing a cyclic olefin resin and at least one compound in a solvent to prepare a dope, casting the dope, drying the cast film, and taking up the film.

Process-II

Process-II includes the steps of dissolving a cyclic olefin resin in a solvent to prepare a dope, casting the dope, drying the cast film, taking up the film, and applying a coating composition containing at least one compound on at least one side of the cast film.

A cyclic polyolefin film excellent in flatness or surface planarity and uniformity and is suitable as an optical film can be obtained by either of these processes.

According to process-I, a dope containing the cyclic polyolefin resin and the compound is cast into film. The compound may be dissolved or dispersed in a solvent together with the cyclic polyolefin, or a solution or dispersion of the compound may be added to the cyclic polyolefin resin dope immediately before casting. Known dispersing equipment can be used to prepare the dispersion, including ordinary stirrers, high-speed stirrers such as a homogenizer, dispersing machines using media such as a ball mill, a paint shaker, and Dynomill, and an ultrasonic dispersing machine. In dispersing the compound in the cyclic polyolefin dope, a small amount of a surface active agent or polymer commonly used as a dispersing aid may be added.

In process-II, the coating composition is any liquid containing the compound. For example, a solution or dispersion of the compound in an appropriate medium is applied to the cast film of the cyclic polyolefin resin. The coating composition may contain a binder to form a layer containing the compound. The coating composition is applied to either one or both sides of the cast film.

The binder that can be used to form the compound-containing layer on the cast film may be either lipophilic or hydrophilic. Examples of lipophilic binders include known thermoplastic, thermosetting, radiation-curing, or reactive resins and mixtures thereof. The binder resins preferably have a Tg of 80° to 400° C., still preferably 120° to 350° C., and a weight average molecular weight of 10,000 to 1,000,000, still preferably 10,000 to 500,000. When the compound is dispersed in a medium, the same dispersing techniques as used in process-I can be used, and a small amount of a surface active agent or polymer commonly used as a dispersing aid may be added.

The thermoplastic resins that can be used as a binder include vinyl copolymers such as vinyl chloride-vinyl acetate copolymers, vinyl chloride-vinyl acetate-vinyl alcohol-(maleic acid and/or acrylic acid) copolymers, vinyl chloride-vinylidene chloride copolymers, vinyl chloride-acrylonitrile copolymers, and ethylene-vinyl acetate copolymers; cellulose derivatives such as nitrocellulose, cellulose acetate propionate, and cellulose acetate butyrate; cyclic polyolefin resins, acrylic resins, polyvinyl acetal resins, polyvinyl butyral resins, polyester polyurethane resins, polyether polyurethane resins, polycarbonate polyurethane resins, polyester resins, polyether resins, polyamide resins, amino resins; rubber resins such as styrene-butadiene resins and butadiene-acrylonitrile resins; silicone resins, and fluororesins.

The thickness of the layer containing the compound is preferably 0.0001 to 10 μm, still preferably 0.001 to 5 μm, even still preferably 0.01 to 1 μm.

The details of the process of producing the cyclic polyolefin film will be given later.

Various other additives such as inhibitors (antioxidants), anti-UV agents, release aids, plasticizers, and IR absorbers may be added to the cyclic polyolefin film as appropriate to the intended use of the film in any stage of film formation. The additives may be each either solid or oily. In other words, the additives are not limited by their melting point or boiling point. For example, a UV absorber (anti-UV agent) whose melting point is below 20° C. and another UV absorber whose melting point is 20° C. or higher may be used in combination. The same applies to a combination of deterioration inhibitors. Useful IR absorbing dyes (IR absorbers) are described, e.g., in JP-A-2001-194522. The additives can be added at any stage of dope preparation. Otherwise, a step of adding additives may be provided as a final stage of dope preparation. The amount of each additive is not particularly limited as long as the expected effect is manifested. When the cyclic polyolefin film has a multilayer structure, the kinds and amounts of the additives may differ between layers.

Useful deterioration inhibitors (antioxidants) include phenol or hydroquinone antioxidants, such as 2,6-di-t-butyl-4-methylphenol, 4,4′-thiobis-(6-t-butyl-3-methylphenol), 1,1′-bis(4-hydroxyphenyl)cyclohexane, 2,2′-methylenebis(4-ethyl-6-t-butylphenol), 2,5-di-t-butylhydroquinone, and pentaerythritol tetrakis[3-(3,5-di-t-butyl-4-hydroxyphenyl)propionate]; and phosphorus antioxidants, such as tris(4-methoxy-3,5-diphenyl) phosphite, tris(nonylphenyl) phosphite, tris(2,4-di-t-butylphenyl) phosphite, bis(2,6-di-t-butyl-4-methylphenyl)pentaerythritol diphosphite, and bis(2,4-di-t-butylphenyl)pentaerythritol diphosphite. The antioxidant is preferably added in an amount of 0.05 to 5.0 parts by weight per 100 parts by weight of the cyclic polyolefin resin.

The UV absorbers are preferably added to the cyclic polyolefin dope for protecting a polarizing plate, an LCD, etc. from deterioration by ultraviolet light. In order to achieve UV absorption while securing liquid crystal display quality, UV absorbers that effectively absorb UV light of 370 nm or shorter wavelengths but absorb little visible light of 400 nm or longer wavelengths are preferred. Suitable UV absorbers for use in the invention include hindered phenol compounds, hydroxybenzophenone compounds, benzotriazole compounds, salicylic ester compounds, benzophenone compounds, cyanoacrylate compounds, and nickel complex compounds. Examples of the hindered phenol compounds are 2,6-di-t-butyl-p-cresol, pentaerythritol tetrakis[3-(3,5-di-t-butyl-4-hydroxyphenyl)propionate], N,N′-hexamethylenebis(3,5-di-t-butyl-4-hydroxy-hydrocinnamide), 1,3,5-trimethyl-2,4,6-tris(3,5-di-t-butyl-4-hydroxybenzyl)benzene, and tris-(3,5-di-t-butyl-4-hydroxybenzyl) isocyanurate. Examples of the benzotriazole compounds are 2-(2′-hydroxy-5′-methylphenyl)benzotriazole, 2,2-methylenebis(4-(1,1,3,3-tetramethylbutyl)-6-(2H-benzotriazol-2-yl)phenol), 2,4-bis(n-octylthio)-6-(4-hydroxy-3,5-di-t-butylanilino)-1,3,5-triazine, triethylene glycol bis[3-(3-t-butyl-5-methyl-4-hydroxyphenyl)propionate], N,N′-hexamethylenebis(3,5-di-t-butyl-4-hydroxy-hydrocinnamide), 1,3,5-trimethyl-2,4,6-tris(3,5-di-t-butyl-4-hydroxybenzyl)_{benzene,} 2-(2′-hydroxy-3′,5′-di-t-butylphenyl)-5-chlorobenzotriazole, 2-(2′-hydroxy-3′,5′-di-t-amylphenyl)-5-chlorobenzotriazole, 2,6-di-t-butyl-p-cresol, and pentaerythritol tetrakis[3-(3,5-di-t-butyl-4-hydroxyphenyl)propionate]. The UV absorber is preferably added in an amount of 1 ppm to 1.0% by weight, still preferably 10 to 1000 ppm, based on the cyclic polyolefin film.

Cyclic polyolefin resins are generally less flexible than cellulose acetate. Cyclic polyolefin resin films are liable to cracking when a flexural or shearing stress is imposed thereon. Furthermore, when processed as an optical film, they tend to develop cracks on their cut area to generate cutting dust. Film cutting dust contaminates an optical film to cause optical defects. The plasticizers can be added to reduce these problems. Examples of suitable plasticizers include phthalic esters, trimellitic esters, aliphatic dibasic acid esters, orthophosphoric esters, acetic esters, polyester epoxidized esters, ricinoleic esters, polyolefins, and polyethylene glycol compounds.

Preferred of them are those which are liquid and have a boiling point of 200° C. or higher at ambient temperature under atmospheric pressure. Specific examples of such plasticizers include aliphatic dibasic esters such as dioctyl adipate (b.p. 230° C./760 mmHg), dibutyl adipate (145° C./4 mmHg), di-2-ethylhexyl adipate (335° C./760 mmHg), dibutyl diglycol adipate (230-240° C./2 mmHg), di-2-ethylhexyl azelate (220-245° C./4 mmHg), and di-2-ethylhexyl sebacate (377° C./760 mmHg); phthalic esters such as diethyl phthalate (298° C./760 mmHg), diheptyl phthalate (235-245° C./10 mmHg), di-n-octyl phthalate (210° C./760 mmHg), and diisodecyl phthalate (420° C., 760 mmHg); and polyolefins such as paraffin waxes having an average molecular weight of 330 to 600 and a melting point of 45° to 80° C. (e.g., n-paraffin, isoparaffin, and cycloparaffin), liquid paraffins (as specified in JIS K2231; e.g., ISO VG 8, VG 15, VG 32, VG 68, and VG100), paraffin pellets (e.g., those having a melting point of 56-58° C., 58-60° C., and 60-62° C.), paraffin chloride, low molecular weight polyethylene, low molecular weight polypropylene, low molecular weight polyisobutene, hydrogenated polybutadiene, hydrogenated polyisoprene, and squalane.

The plasticizer is added in an amount of 0.5 to 40.0 parts, preferably 1.0 to 30.0 parts, still preferably 3.0 to 20.0 parts, by weight per 100 parts by weight of the cyclic polyolefin resin. Use of less than 0.5 parts produces insufficient effect, bringing no improvement on process ability. Addition of more than 40 parts can result in bleeding of the plasticizer during long term storage, causing optical unevenness and contamination of other parts.

The process of producing the cyclic polyolefin film of the invention will now be described in detail.

Although the cyclic polyolefin film of the invention is not limited by its production process, it is produced by melt casting or solvent casting. Solvent casting is preferred. The above mentioned processes I and II are particularly preferred. It is preferred that the casting step in each of processes I and II be followed by the step of stretching.

Processes I and II are different in the manner of incorporating the compound into the cyclic polyolefin film. In process I, the compound is uniformly distributed in the layer of the cyclic polyolefin resin. In process II, the compound is applied in the form of liquid to the cyclic polyolefin resin film. Processes I and II will be described with reference to each of the steps involved starting with dissolving (dope preparation) and ending with winding after drying. The step of dope preparation in process I is the same as that in process II, except that the compound is added and dissolved or dispersed.

(1) Step of Dissolving (Dope Preparation Step)

Necessary components are dissolved in a solvent (described infra) to prepare a cyclic polyolefin solution, namely dope. The dope preparation can be achieved by, for example, a room-temperature dissolving method in which the system is stirred at room temperature, a cooling dissolving method in which the system is stirred at room temperature to swell the polymer including the cyclic polyolefin resin, cooled to −20° to −100° C., and heated to 20° to 100° C. to dissolve the polymer, a high-temperature dissolving method in which the system is heated in a closed container to a temperature at or above the boiling point of the main solvent to dissolve the polymer, or a method in which the temperature and pressure are raised up to the critical point of the solvent to dissolve the polymer. A dope of a soluble polymer is preferably prepared by the room-temperature dissolving method. A dope of a hardly soluble polymer is preferably prepared by the method by heating in a closed container. Unless the polymer has poor solubility, to choose a dissolving temperature as low as possible gives a process convenience.

The cyclic polyolefin solution preferably has a viscosity of 1 to 500 Pa·s, still preferably 5 to 200 Pa·s, at 25° C. The viscosity measurement is made on 1 ml of a sample solution with a rheometer CSL 500 (from TA Instruments Inc.) using a stainless steel cone and plate geometry (cone diameter of 4 cm and angle of 2°) (from TA Instruments). The measurement is taken after maintaining the sample solution at the measuring temperature (25° C.) until the sample temperature becomes stationary.

The organic solvents to be used in the dope preparation is not particularly limited as long as the object is accomplished, that is, as long as the cyclic polyolefin dissolves therein to give a castable, film-forming solution called a dope. Exemplary solvents to be used include chlorine-containing solvents, such as dichloromethane and chloroform, acyclic, cyclic or aromatic hydrocarbons having 3 to 12 carbon atoms, esters having 3 to 12 carbon atoms, ketones having 3 to 12 carbon atoms, and ethers having 3 to 12 carbon atoms. The esters, ketones and ethers may have a cyclic structure. The acyclic hydrocarbons having 3 to 12 carbon atoms include hexane, octane, isooctane, and decane. The cyclic hydrocarbons having 3 to 12 carbon atoms include cyclopentane, cyclohexane, and derivatives thereof. The aromatic hydrocarbons having 3 to 12 carbon atoms include benzene, toluene, and xylene. The esters having 3 to 12 carbon atoms include ethyl formate, propyl formate, pentyl formate, methyl acetate, ethyl acetate, and pentyl acetate. The ketones having 3 to 12 carbon atoms include acetone, methyl ethyl ketone, diethyl ketone, diisobutyl ketone, cyclopentanone, cyclohexanone, and methylcyclohexanone. The ethers having 3 to 12 carbon atoms include diisopropyl ether, dimethoxymethane, dimethyloxyethane, 1,4-dioxane, 1,3-dioxolane, tetrahydrofuran, anisole, and phenetole. Organic solvents having two or more kinds of functional groups are also preferred, including 2-ethoxyethyl acetate, 2-methoxyethanol, and 2-butoxyethanol. The organic solvent preferably has a boiling point of 35° to 150° C. Two or more kinds of the solvents can be used to control the drying properties of the dope and the solution properties such as viscosity. It is also possible to add a poor solvent as long as the mixed solvent system is capable of dissolving the polymer.

The poor solvent to be used is selected as appropriate to the kind of the polymer. Where a chlorine-containing organic solvent is used as a good solvent, an alcohol is a preferred poor solvent. The alcohol may be straight, branched or cyclic. A saturated aliphatic hydrocarbon is preferred. The hydroxyl group of the alcohol may be primary, secondary or tertiary. Examples of the alcohol are methanol, ethanol, 1-propanol, 2-propanol, 1-butanol, 2-butanol, t-butanol, 1-pentanol, 2-methyl-2-butanol, and cyclohexanol. A fluoroalcohol such as 2-fluoroethanol, 2,2,2-trifluoroethanol, or 2,2,3,3-tetrafluoro-1-propanol is also useful. Of these poor solvents, monohydric alcohols are preferably used for their effect in reducing resistance to peeling. While a choice of an alcohol as a poor solvent depends on the good solvent selected, preferred for the consideration of drying load are those having a boiling point of 120° C. or lower, more preferred are monohydric ones having 1 to 6 carbon atoms, even more preferred are those having 1 to 4 carbon atoms. A particularly preferred solvent system for preparing a cyclic polyolefin resin solution comprises dichloromethane as a main solvent and at least one poor solvent selected from methanol, ethanol, propanol, isopropyl alcohol, and butanol.

With the solvent to be used being properly chosen, the cyclic polyolefin allows for preparation of a high-concentration and yet highly stable dope without requiring the operation of concentration. Understandably, the operation of concentration may be used when a polymer solution at a lower concentration is once prepared and then concentrated to a desired concentration to make the operation of dissolving easier. Concentration can be carried out by any method. For example, the method of JP-A-4-259511 is useful, in which a low concentration solution is introduced into a cylinder between the inner wall of the cylinder and the periphery of a rotating blade rotating along the inner wall of the cylinder while affording a temperature difference to the solution thereby causing the solvent to evaporate. The method disclosed in U.S. Pat. Nos. 2,541,012, 2,858,229, 4,414,341, and 4,504,355 is also practical, in which a heated low-concentration solution is sprayed into a container from a nozzle, and the solvent is flash-evaporated before the solution strikes against the inner wall of the container. The solvent vapor is driven out of the container, and the concentrated solution is withdrawn from the bottom of the container.

The dope thus prepared is preferably filtered through an appropriate filter media such as a metal wire cloth or flannel to remove insoluble matter and foreign matter (e.g., dust and impurity). To filter the cyclic polyolefin dope it is preferred to use a filter with an absolute filtration rating of 0.1 to 100 μm, more preferably 0.5 to 25 μm. The filter thickness is preferably 0.1 μm to 10 mm, more preferably 0.2 to 2 mm. With that thickness, the filtration pressure is preferably 1.6 MPa or lower, more preferably 1.3 MPa or lower, even more preferably 1.0 MPa or lower, still more preferably 0.6 MPa or lower. Filter media of known materials including glass fiber, cellulose fiber, filter paper, and fluororesins such as polytetrafluoroethylene are used. Filter media made of ceramics or metals are also suitable.

The viscosity of the dope immediately before casting should be within a range suitable for casting, which is preferably from 5 to 1000 Pa·s, more preferably 15 to 500 Pa·s, even more preferably 30 to 200 Pa·s. The temperature of the dope immediately before casting should be within a range of the temperature at the casting, which is preferably −5° to 70° C., more preferably −5° to 35° C.

Solvent casting using the cyclic polyolefin dope is preferably carried out using methods and equipment conventionally employed in the formation of a cellulose triacetate film. The following is a preferred embodiment of cyclic polyolefin film formation by solvent casting, which is not limiting the invention.

A cyclic polyolefin dope prepared in a dissolving vessel is once stored in a storage tank for defoaming. The thus obtained final dope is fed to a pressure die through a pressure pump, e.g., a constant displacement gear pump capable of precise metering by the number of rotations, and uniformly cast through the slot of the pressure die on an endlessly moving metal support. When the dope on the support makes almost one revolution and reaches a peeling position, by which time the dope has half-dried, the half-dried dope called a web is peeled off the support. The web is dried while being conveyed by a tenter with its width fixed by clips, finally dried while moving on a group of rolls in a dryer, and taken up on a winder with a prescribed length. The combination of the tenter and the dryer having rolls is subject to alteration depending on the purpose. Where a functional protective film for application to electronic displays is produced, the solvent casting equipment is often combined with coaters to provide a functional layer, such as an undercoating layer, an antistatic layer, an anti-halation layer, or a protective layer, on the cast film. Each of the steps involved in the formation of the cyclic polyolefin film will be briefly illustrated below, but the invention is not restricted thereto.

The finally prepared dope is preferably cast on an endless metallic support, e.g., a drum or a belt, and the solvent is made to evaporate to form a film. The dope to be cast is preferably adjusted to have a cyclic polyolefin content of 10% to 35% by weight. The surface of the support is preferably mirror finished. The support surface temperature is preferably 30° C. or lower, more preferably −50° to 20° C. The film forming techniques taught in JP-A-2000-301555, JP-A-2000-301558, JP-A-7-32391, JP-A-3-193316, JP-A-5-86212, JP-A-62-37113, JP-A-2-276607, JP-A-55-14201, JP-A-2-111511, and JP-A-2-208650 can be made use of.

(2) Step of Casting

Solvent casting may be carried out using a single cyclic polyolefin dope, or two or more dopes may be cast on the same support to obtain a multilayered cast film. Multilayered cast film can be formed by successively casting the dopes through the respective dies provided at spacing in the moving direction of the support. The techniques described in JP-A-61-158414, JP-A-1-122419, and JP-A-11-198285 can be utilized. Multilayered cast film may also be obtained by co-casting two dopes through the respective die slots as described, e.g., in JP-B-60-27562, JP-A-61-94724, JP-A-61-947245, JP-A-61-104813, JP-A-61-158413, and JP-A-6-134933. The solvent casting technique proposed in JP-A-56-162617 is also useful, in which a flow of a high viscosity dope is surrounded by a flow of a low viscosity dope, and the two dopes are simultaneously extruded onto a support. In a preferred embodiment, the content of an alcohol component as a poor solvent is made higher in the outer dope than in the inner dope as proposed in JP-A-61-94724 and JP-A-61-94725. The technique disclosed in JP-B-44-20235 is also useful, in which a cast film formed by casting a first dope on a support from a first die is peeled, and a second dope is cast from a second die onto the cast film on the side that has been in contact with the support. The two or more cyclic polyolefin dopes used in these multilayer casting techniques may be either the same or different. To impart different functions to two or more cyclic polyolefin cast layers, cyclic polyolefin dopes appropriate for the respective functions may be extruded from the respective slots. It is also possible to co-cast the cyclic polyolefin dope simultaneously with other functional layers (for example, an adhesive layer, a dye layer, an antistatic layer, an anti-halation layer, a matte layer, a UV absorbing layer, and a polarizing layer).

To achieve a required film thickness by single layer casting, it is necessary to extrude a high-concentration, high-viscosity cyclic polyolefin dope. Such a dope has poor stability and tends to form solid matter, which can often cause machine trouble, or result in formation of a cast film with poor surface planarity. The above described multilayer casting provides a solution to this problem. Since a plurality of highly viscous dopes are cast from the respective die slots on a metal support simultaneously, the resulting cast film exhibits excellent surface properties such as improved planarity. Furthermore, use of thick dopes contributes to decrease in drying load and increase of production speed.

In the case of co-casting, the thickness of the inner layer and that of the outer layer are not particularly limited. It is preferable that the outer thickness is 1% to 50%, more preferably 2% to 30%, of the total thickness. In the case of co-casting three or more layers, the total film thickness of the layer having been in contact with the metal support and the layer having been in contact with the atmosphere is defined as “outer thickness”. Cyclic polyolefin dopes differing from each other in concentrations of the above-described additives can be co-cast to form a cyclic polyolefin film having a multilayered structure. For example, a cyclic polyolefin laminate film having a skin layer/core layer/skin layer structure can be obtained. In this layer structure, a deterioration inhibitor and a UV absorber may be added in larger amounts to the core layer than to the skin layer or added only to the core layer. The kind of deterioration inhibitors or UV absorbers may be changed between the core layer and the skin layers. For example, a less volatile deterioration inhibitor and/or UV absorber may be added to the skin layers, while a plasticizer having an excellent plasticizing effect or a UV absorber showing high UV absorption may be added to the core layer. It is also a preferred embodiment to add a release agent only to the support side skin layer. In case of chill-roll extrusion, since the dope is gelled by cooling the metal support, it is preferred to add an alcohol, i.e., a poor solvent in a larger amount to the skin layer than to the core layer. The skin layers and the core layer may have different Tgs. It is preferred that the Tg of the core layer be lower than that of the skin layer. The dopes for the skin layer and the core layer may have different viscosities. While it is usually preferred that the viscosity of the skin layer be lower than that of the core layer, the viscosity of the core layer may be lower than that of the skin layer.

Casting a dope is carried out by, for example, a method wherein a prepared dope is uniformly extruded from a pressure die onto a metal support, a method in which a dope once cast on a metal support is leveled with a doctor blade to control the film thickness or a method using a reverse roll coater in which the film thickness is adjusted by a roll rotating in the reverse direction. The method using a pressure die is preferred. Pressure dies include a coat hanger type and a T-die type, each of which can be used preferably. In addition to the methods described above, use can be made of various solvent casting techniques known for forming a cellulose triacetate film. By properly selecting conditions taking the differences, e.g., in boiling point of solvents into consideration, the same effects and advantages as reported in the publications will be obtained.

The continuously moving metal supports to be used in solvent casting include a drum having the surface mirror finished by chrome plating and a stainless steel belt or band having the surface mirror polished. One or more pressure dies are provided above the metal support. A preferred number of the pressure dies is one or two. Where two or more pressure dies are provided, the dope to be cast may be divided into portions in amounts appropriate for the respective dies. It is also possible to feed the dope in predetermined amounts into the dies by using respective precise metering gear pumps. The temperature of the cyclic polyolefin dope to be cast preferably ranges from −10° to 55° C., more preferably from 25° to 50° C. The dope temperature may be maintained constant throughout the process involved or vary from stage to stage. In the latter case, the temperature should be at a prescribed level immediately before being cast.

(3) Step of Drying

The cyclic polyolefin web on the metal support is dried usually by blowing hot air to the metal support (a drum or a belt), i.e., the exposed side of the web on the metal support or to the inner side of the drum or belt, or applying a temperature-controlled liquid to the inner side of the drum or belt (i.e., the side opposite to the casting side) to heat the drum or the belt by heat transfer and control the surface temperature. The liquid heat transfer method is preferred. The surface temperature of the metal support before casting is not limited as long as it is below the boiling points of the solvents used in the dope. To promote the drying or the loss of fluidity of the web on the metal support, it is preferred to set the support surface temperature lower than the lowest boiling point of the solvents used in the dope by 1° to 10° C. This does not apply, however, to the case where the web is peeled after cooling without drying.

(4) Step of Peeling

Where a half-dried web has high peel resistance or requires high peeling load when peeled off the metal support, irregular stretching can occur in the machine direction to develop optical unevenness (anisotropy). With an appreciable peel resistance, the film can discontinuously undergo stretching in the machine direction, resulting in alternation of stretched parts and unstretched parts along the machine direction, which causes a distribution of retardation. When an optical film with such a distribution of retardation is applied to LCDs, streaky or banded unevenness would appear. To avert this problem, it is preferred to limit the peeling load of the film to 0.25 N or less per cm of the peel width. The peeling load is more preferably 0.2 N/cm or less, even more preferably 0.15 N/cm or less, still more preferably 0.10 N/cm or less. When the peeling load of a film is 0.2 N/cm or less, unevenness developed on peeling will not at all appear even when the film is applied to an LCD on which unevenness is easily visualized. Reduction of peeling load can be accomplished by addition of a release agent as previously stated or by proper selection of the solvent system.

A peeling load is measured as follows. A dope is dropped on a metal plate made of the same material and having the same surface roughness as the metal support of a film forming apparatus. The dope is spread to a uniform thickness with a doctor blade and dried. The film as formed on the plate is cut into strips of the same width with a retractable knife. One end of each strip is peeled off the plate with fingers and held by a clip connected to a strain gauge. The strip is peeled at 45° by obliquely lifting the strain gauge to record the change in load. The residual volatile content of the peeled strip of the film is measured. The same measurements are repeated several times while varying the drying time. The peeling load required to peel the strip having the same residual volatile content as in an actual peeling step is obtained. Because the peeling load tends to increase with an increase of peeling speed, the measurement is preferably conducted at a peeling speed close to an actual speed.

A preferred residual volatile content at the peeling is preferably 5% to 60% by weight, more preferably 10% to 50% by weight, even more preferably 20% to 40% by weight. Peeling a cast film while a high volatile content remains allows for raising the speed of drying, which means improvement of productivity. A film with too high a residual volatile content, however, has too small strength and elasticity to withstand the peeling force and easily cuts or stretches when peeled. Besides, a film with too high a residual volatile content has poor self-supporting properties after being peeled and easily undergoes film defects, such as deformation, wrinkles, and knicks, and creates a distribution of retardation.

(5) Step of Stretching

Where the process includes the step of stretching the cyclic polyolefin film, stretching is preferably carried out shortly after the peeling, in other words, while a sufficient amount of the solvent remains in the film. The purpose of stretching is (1) to provide the film with excellent flatness or planarity free from wrinkles or deformation and/or (2) to enhance the in-plane retardation of the film. For the purpose (1), the stretching is preferably performed at a relatively high temperature at a stretch ratio of from 1% to 10% at the most, more preferably 2% to 5%. For the purpose (2) or for the purposes (1) and (2), the stretching is preferably carried out at a relatively low temperature at a stretch ratio of 5% to 150%.

The stretching is either uniaxial (MD or TD) or biaxial (either simultaneous or successive). A retardation film (birefringent optical film) applied to a VA mode liquid crystal cell or an OCB mode liquid crystal cell preferably has a larger refractive index in the width direction than in the length direction. Accordingly, it is recommended to stretch the film at a higher ratio in the width direction than in the length direction.

(6) Step of Post-Drying and Winding

The stretched cyclic polyolefin is subjected to post-drying to reduce the residual volatile content to 2% or lower before being wound into roll.

The thickness of the cyclic polyolefin film after drying varies depending on the intended use. It usually ranges from 20 to 60 μm.

A desired film thickness can be obtained by adjusting the solids concentration of the dope, the slot gap of the die, the extrusion pressure from the die, the moving speed of the metal support, and the like. The width of the cyclic polyolefin film thus obtained is preferably 0.5 to 3 m, more preferably 0.6 to 2.5 m, even more preferably 0.8 to 2.2 m. Productivity is secured with a film width of at least 0.5 m. With the width being 3 m or smaller, the web handling properties and optical uniformity of the film are secured, and unfavorable phenomena such as film twisting or streaking do not occur. The length of the film wound per roll is preferably 100 to 10,000 m, more preferably from 500 to 7,000 m, even more preferably 1,000 to 6,000 m. With the length of at least 100 m, the frequency of changing rolls is not so high as to reduce the productivity. With the length being 10000 m or less, the web handling properties and optical uniformity of the film are secured, and unfavorable phenomena such as film twisting or streaking do not occur.

Before being taken up, the film is preferably knurled along at least one margin thereof from one or both sides thereof. The knurling width is preferably 3 to 50 mm, more preferably 5 to 30 mm, and the knurling height is preferably 0.5 to 500 μm, more preferably from 1 to 200 μm.

Variation in Re in the width direction is preferably within 5 nm, more preferably ±3 nm. Variation in Rth in the width direction is preferably ±10 nm, more preferably ±5 nm. The same preference applies to variations in Re and Rth in the longitudinal direction. To secure transparency, the haze of the film is preferably 0.01% to 2%.

Preferred optical characteristics of the cyclic polyolefin film of the invention vary according to the intended use as long as the above recited conditions (1) and (2) are satisfied. Preferred optical characteristics of the film for use as a polarizer protective film and an optical compensation film will be described.

The cyclic polyolefin film of the invention can be designed to have desired optical characteristics by properly selecting the polymer structure, the kind and amount of additives, the stretch ratio, the residual volatile content at peeling, and the like.

In-plane retardation at a wavelength λ, Re (X), is measured for light having a wavelength of λ nm incident normal to the film surface with a phase difference measurement system KOBRA 21ADH (from Oji Scientific Instruments). Thickness direction retardation at a wavelength λ, Rth(λ), is calculated by KOBRA 21ADH based on six retardation values measured for light of a wavelength λ nm incident in varied directions: first is the Re(λ) obtained above and second to sixth are retardation values measured for light incident in a direction tilted (rotated) at an angle increasing in 10° increments from the normal direction of the film about the in-plane slow axis, which is decided by KOBRA 21ADH, as an axis of tilt (rotation). Where there is no slow axis, any in-plane direction of the film will be an axis of tilt. An assumed average refractive index and the thickness of the film are also needed for calculation. The Rh may also be calculated from two retardation values measured in two different directions in the same manner as described above, the assumed average refractive index, and the thickness of the film based on the following equalities (1) and (2). The assumed average refractive indices are listed in Polymer Handbook, John Wily & Sons, Inc. or available catalogues of optical films. Otherwise, the average refractive indices may be measured with an Abbe refractometer. Typical optical films and their average refractive indices are: cellulose acylate (1.48), cycloolefin polymer (1.52), polycarbonate (1.59), polymethyl methacrylate (1.49), and polystyrene (1.59). With the assumed average refractive index and the thickness inputted, KOBRA 21ADH calculates nx, ny, and nz, from which is calculated Nz (=(nx−nz)/(nx−ny)).

$$Re ( θ ) = [ nx - \frac{ny \times nz}{\sqrt{\begin{matrix}{( ny sin ( {sin}^{- 1} ( \frac{sin ( - θ )}{nx} ) ) )}^{2} + \\ {( nz cos ( {sin}^{- 1} ( \frac{sin ( - θ )}{nx} ) ) )}^{2}\end{matrix}}} ] \times \frac{d}{cos ( {sin}^{- 1} ( \frac{sin ( θ )}{nx} ) )} \qquad Equality ( 1 )$$

where Re(θ) represents a retardation for light incident in a direction titled by an angle θ from the normal direction.
Rth=((nx+ny)/2−nz)×d Equality (2)

The average refractive index n, a necessary parameter, was obtained by measurement with an Abbe refractometer 2-T from Atago Co., Ltd.

Applications of the cyclic polyolefin film of the invention to a polarizer protective film and an optical compensation film and a polarizing plate including the protective film will be described.

In application to a retardation film, suitable Re and Rth ranges vary depending on the use, and there are diversified needs for retardation films. The cyclic polyolefin film of the invention as a retardation film is particularly suited as an optical compensation film. The optical compensation film may be formed solely of the cyclic polyolefin film of the invention or may contain other layer(s). The cyclic polyolefin resin providing the optical compensation film preferably contains a highly polarizable substituent in its molecule in an appropriate proportion.

In application as a polarizer protective film of a polarizing plate, the cyclic polyolefin film of the invention preferably has an in-plane retardation (Re) of 5 nm or smaller, more preferably 3 nm or smaller, and a thickness direction retardation (Rth) of 50 nm or smaller, more preferably 35 nm or smaller, even more preferably 10 nm or smaller. The protective film may be formed solely of the cyclic polyolefin film of the invention or may contain other layer(s).

A polarizing plate usually has a polarizer and two transparent protective films each disposed on each side of the polarizer. The polarizer protective film of the present invention is used on both sides or one side of a polarizer. In the latter application, the protective film on the opposite side can be of a conventional film such as a cellulose triacetate film.

Polarizers include an iodine polarizer, a dichroic polarizer, and a polyene polarizer. The iodine polarizer and the dichroic polarizer are generally prepared using polyvinyl alcohol (PVA) film. PVA is a polymeric material obtained by saponification of polyvinyl acetate. It may contain a component copolymerizable with vinyl acetate, such as an unsaturated carboxylic acid, an unsaturated sulfonic acid, an olefin or a vinyl ether. A modified PVA containing an acetoacetyl group, a sulfonic acid group, a carboxyl group, an oxyalkylene group, etc. is useful as well.

The degree of saponification of the PVA is preferably, but not limited to, 80 to 100 mol %, still preferably 90 to 100 mol %. The degree of polymerization of the PVA is preferably, but not limited to, 1000 to 10000, still preferably 1500 to 5000.

The PVA preferably has a degree of syndiotacticity of 55% or higher to have improved durability as taught in Japanese Patent 2978219. PVA having a degree of syndiotacticity of 45 to 52.5% as described in Japanese Patent 3317494 is also used preferably.

For application as a polarizer protective film or a retardation film, it is preferred that the cyclic polyolefin film be subjected to a surface treatment described below on its surface to be adhered to a polarizer via an adhesive. The polarizing plate composed of the polarizer and a protective film on both sides thereof further has a releasable protective sheet on one side thereof and a releasable separate sheet on the other side. Both the releasable protective sheet and separate sheet provide the polarizing plate with a protection during shipment or inspection of the polarizing plate. The protective sheet is for protecting the viewer's side of the polarizing plate, while the separate sheet is for covering an adhesive layer with which the polarizing plate is to be bonded to a liquid crystal panel.

The polarizer protective film is preferably bonded to the polarizer with its slow axis coincident with the transmission axis of the polarizer. Evaluation of a polarizing plate constructed under crossed Nicols revealed that, if a deviation from perpendicularity between the slow axis of the cyclic polyolefin film and the absorption axis of the polarizer (orthogonal to the transmission axis of the polarizer) exceeds 1°, the polarizing performance under crossed Nicols reduces to cause light leakage. When combined with a liquid crystal cell, such a polarizing plate would fail to provide a sufficient black level or contrast. It is therefore desirable that the deviation of the direction of the main refractive index nx of the protective film from the transmission axis of the polarizer be within 1°, more desirably within 0.5°.

Single polarizer transmittance (Tt), parallel pair transmittance (Tp), and crossed pair transmittance (Tc) can be measured with UV3100PC (from Shimadzu Corp.). Measurements are made in a wavelength range of from 380 to 780 nm. Measurements are repeated 10 times for each of Tt, Tp, and Tc to obtain the respective averages.

A polarizing plate can be tested for durability using (1) two samples each prepared by superposing two polarizing plates crosswise with the protective films of the invention facing each other and (2) two samples (about 5 cm by 5 cm) each composed of a single polarizing plate bonded to a glass plate with the protective film of the invention facing the glass plate. The single polarizer transmittance (Tt) is measured using each of the two glass-supported samples with its polarizing plate side facing a light source to obtain an average. Favorable polarizing performance of the polarizing plate is 40.5≦Tt≦45, 32≦Tp≦39.5, and Tc≦1.5; more favorably 41.0≦Tt≦44.5, 34≦Tp≦39.0, and Tc≦1.3. It is desirable that difference in polarizing performance between before and after the durability test be minimized.

As noted above, the cyclic polyolefin protective film is preferably subjected to any surface treatment for enhancing the adhesion to a polarizer. Suitable surface treatments include a glow discharge treatment, a UV irradiation treatment, a corona treatment, and a flame treatment. The glow discharge treatment as referred to here is a low-temperature plasma treatment under a low gas pressure or a plasma treatment under atmospheric pressure. For the details of the glow discharge treatment, reference can be made to U.S. Pat. Nos. 3,462,335, 3,761,299, and 4,072,769 and British Patent 891469. The method described in JP-A-59-556430 is also applicable, in which the gas composition of the discharge atmosphere is limited to only a gas species generated within a chamber when, after starting the discharge, a polyester support itself is subjected to a discharge treatment. The technique proposed in JP-B-60-16614 is effective as well, in which a vacuum glow discharge treatment is carried out at a film surface temperature of 80° C. to 180° C.

The glow discharge treatment is preferably carried out under conditions of a degree of vacuum of 0.5 to 3000 Pa, more preferably 2 to 300 Pa, a voltage of 500 to 5000 V, more preferably 500 to 3000 V, and a discharge frequency of from direct current to several thousands of megahertzs, more preferably 50 Hz to 20 MHz, even more preferably 1 KHz to 1 MHz. The discharge treatment intensity is preferably 0.01 to 5 kV·A·min/m², more preferably 0.15 to 1 kV·A·min/m².

The UV irradiation treatment is also a preferred surface treatment. The UV treatment is performed by, for example, the methods described in JP-B-43-2603, JP-B-43-2604, and JP-B-45-3828. A mercury lamp can be used as a UV light source. A high pressure mercury lamp having a quartz tube that emits UV light having a wavelength of 180 to 380 nm is preferred. Unless it is problematical for the film to have its surface temperature raised to around 150° C., a high pressure mercury lamp having a dominant wavelength of 365 nm can be used. Where the UV treatment should be at a lower temperature, a low pressure mercury lamp having a dominant wavelength of 254 nm is preferred. An ozonless type high pressure and low pressure mercury lamp are also usable. The higher the radiation intensity, the higher the adhesion of the irradiated cyclic olefin resin film to a polarizer. Nevertheless, the film becomes colored and brittle with an increase in radiation intensity. A recommended radiation intensity in using a high pressure mercury lamp having a main wavelength of 365 nm is 20 to 10000 mJ/cm², preferably 50 to 2000 mJ/cm², and that in using a low pressure mercury lamp is 100 to 10000 mJ/cm², preferably 300 to 1500 mJ/cm².

The corona discharge treatment is also a preferred surface treatment. The corona discharge treatment can be carried out in accordance with the methods described, e.g., in JP-B-39-12838, JP-A-47-19824, JP-A-48-28067, and JP-A-52-42114. Suitable commercially available corona treaters include the solid state corona treater manufactured by Pillar Technologies, Inc., a Lepel type corona discharge treater, and a Vetaphon type corona discharge treater. The treatment can be conducted in air at atmospheric pressure. The discharge voltage is preferably 5 to 40 kHz, more preferably 10 to 30 kHz. The waveform is preferably an alternating current sine wave. The gap clearance between the electrode and the dielectric roll is preferably 0.1 to 10 mm, more preferably 1.0 to 2.0 mm. The film is passed to a corona discharge treatment zone, wherein it is subjected to a corona discharge preferably of 0.34 to 0.4 kV·A·min/m², more preferably 0.344 to 0.38 kV·A·min/m², while passing over the upper part of a dielectric support roll.

The flame treatment is also a preferred surface treatment. While any of natural gas, liquefied propane gas, and city gas can be used, a mixing ratio with air is of importance because it is considered that the effect of a flame treatment is brought about by plasma containing active oxygen. The activity (temperature) of plasma, which is an important property of a flame, and how much of the oxygen is present are key points. These key points are governed by the gas to oxygen ratio. When the gas and oxygen react neither too much nor too little, a highest energy density is reached, producing high plasma activity. Specifically, a natural gas to air mixing ratio (by volume, hereinafter the same) is preferably 1/6 to 1/10, more preferably 1/7 to 1/9; a liquefied propane gas to air mixing ratio is preferably 1/14 to 1/22, more preferably 1/16 to 1/19; and a city gas to air mixing ratio is preferably 1/2 to 1/8, more preferably 1/3 to 1/7. The amount of flame treatment is preferably 1 to 50 kcal/m², more preferably 3 to 20 kcal/m². The distance between the tip of the inner cone of the burner flame and the film is generally 3 to 7 cm and, more preferably 4 to 6 cm. The shape of the nozzle of the burner is preferably a ribbon type by Flynn Burner Corp., a multi-hole type by the Wise Ltd., the U.S., ribbon type by Aerogen Inc., the U.K., a staggered multi-hole type by Kasuga Electric Co. Ltd., Japan, and a staggered multi-hole type by Koike Oxygen Co., Ltd., Japan. The back-up roll for holding the film is preferably made of a hollow cylinder roll that is water-cooled so that the treatment can be performed at a constant temperature between 20° and 50° C.

A preferred degree of the surface treatment, while dependent on the surface treatment and the cyclic polyolefin, is such that the resultant film surface may have a contact angle smaller than 50°, preferably 25° or greater and smaller than 45°, with pure water to exhibit good adhesion to a polarizer.

An adhesive containing a water soluble polymer is preferably used to bond the cyclic polyolefin protective film, preferably as surface treated, to a PVA-based polarizer. Examples of preferred water soluble polymers include a homo- or copolymer containing a unit of an ethylenically unsaturated monomer, such as N-vinylpyrrolidone, acrylic acid, methacrylic acid, maleic acid, β-hydroxyethyl acrylate, β-hydroxyethyl methacrylate, vinyl alcohol, methyl vinyl ether, vinyl acetate, acrylamide, methacrylamide, diacetonacrylamide or vinylimidazole; polyoxyethylene, polyoxypropylene, poly-2-methyloxazoline, methyl cellulose, hydroxyethyl cellulose, hydroxypropyl cellulose, and gelatin. PVA and gelatin are particularly preferred of them.

The properties desirable for PVA as an adhesive are the same as those described above which are desirable for the PVA used in the polarizer. In the present invention, it is preferred to use a crosslinking agent in combination with PVA. Examples of crosslinking agents suited to be combined with a PVA adhesive are boric acid, polyaldehydes, polyfunctional isocyanate compounds, and polyfunctional epoxy compounds, with boric acid being particularly preferred.

Gelatin species that can be used as an adhesive include lime processed gelatin, acid processed gelatin, enzyme processed gelatin, gelatin derivatives, and modified gelatin. Lime processed gelatin and acid processed gelatin are preferred of them. Crosslinking agents that can preferably be used in combination with gelatin include active halogen compounds, such as 2,4-dichloro-6-hydroxy-1,3,5-triazine and its sodium salt; active vinyl compounds, such as 1,3-bis(vinylsulfonyl)-2-propanol, 1,2-bis(vinylsulfonylacetamido)ethane, bis(vinylsulfonylmethyl)ether, and vinyl polymers having a vinylsulfonly group in the side chain; N-carbamoylpyridinium salts, such as (1-morpholinocarbonyl-3-pyridinio)methanesulfonate; and haloamidinium salts, such as 1-(1-chloro-1-pyridinomethylene)pyrrolidinium 2-naphthalenesulfonate. The active halogen compounds and the active vinyl compounds are particularly preferred.

A preferred amount of the crosslinking agent to be added if needed is 0.1 parts or more and less than 40 parts, more preferably 0.5 parts or more and less than 30 parts, by weight per 100 parts by weight of the water soluble polymer in the adhesive. The adhesive is preferably applied to at least one of the protective film and a polarizer to form an adhesive layer, via which the two are bonded. More preferably, the adhesive is applied to the surface-treated side of the protective film. The thickness of the adhesive layer is preferably 0.01 to 5 μm, more preferably 0.05 to 3 μm, on dry basis.

It is preferable to provide a functional layer, such as an antireflective layer, on the transparent protective film on the opposite side of the polarizer to a liquid crystal cell. The polarizing plate of the invention preferably has (a) an antireflective layer composed of a light scattering sublayer and a low refractive index sublayer stacked in that order on the transparent protective film or (b) an antireflective layer composed of a medium refractive index sublayer, a high refractive index sublayer, and a low refractive index sublayer stacked in that order on the transparent protective film.

The antireflective layer composed of a light scattering sublayer and a low refractive index sublayer is described first. The light scattering sublayer preferably contains matte particles dispersed therein. The light scattering sublayer may have an antiglare function and a hard coat function. The light scattering sublayer may have a single layer structure or a multilayer structure composed of, for example, two to four subdivided layers.

The antireflective layer is preferably designed to have the following surface profile: Ra (roughness average) of 0.08 to 0.40 μm; Rz (10 point height parameter) of not more than 10 times the Ra; Sm (a mean spacing between peaks at the mean line) of 1 to 100 μm; a standard deviation of the peak heights measured from the deepest valley of 0.5 μm or less; a standard deviation of Sm of 20 μm or less; and the proportion of the slopes at 0° to 5° of 10% or more. The antireflective layer satisfying the above surface profile parameters achieves sufficient antiglare performance and a uniform matte appearance observed with the naked eye.

In order for reflected light to have a neutral tint, the reflected light on the antireflective layer preferably has an a* value of from −2 to 2 and a b* value of from −3 to 3 under a standard light source C, and a minimum to maximum refractive index ratio in a wavelength region of from 380 to 780 nm is preferably 0.5 to 0.99. It is also preferable for reducing yellowness of white display that the b* value of transmitted light be 0 to 3 under a standard light source C. Furthermore, when a brightness of the antireflective layer is measured with a gratin g of 40 μm by 120 μm placed between a planar light source and the antireflective layer, it is preferred that the brightness distribution have a standard deviation of 20 or less about the mean value. With this brightness distribution, the polarizing plate applied to a high definition panel has reduced glare.

The antireflective layer preferably has a specular reflectance of 2.5% or lower, a transmittance of 90% or higher, and a 60° gloss of 70% or less. With these optical characteristics, reflection of external light is suppressed to improve the display visibility. The specular reflectance is more preferably 1% or less, even more preferably 0.5% or less. To achieve no-glare and clarity of text when applied to high definition LCD panels, the antireflective layer preferably has a haze of 20% to 50%, an internal haze to total haze ratio of 0.3 to 1, a difference between the haze of the light scattering sublayer with no low refractive index sublayer formed thereon and the haze of the light scattering sublayer and the low refractive index sublayer formed thereon of 15% or less, a transmitted image clarity at an optical comb width of 0.5 mm of from 20% to 50%, and a transmittance ratio of vertically incident light/light incident at 2° deviation from the vertical direction of from 1.5 to 5.0.

The low refractive index sublayer that can be used to make the antireflective layer preferably has a refractive index of 1.20 to 1.49, still preferably 1.30 to 1.44. To ensure low refractivity, the low refractive index sublayer preferably satisfies formula:
(m/4)λ×0.7<n1d1<(m/4)λ×1.3
where m is a positive odd number; n1 is the refractive index of the low refractive index sublayer; d1 is the thickness (nm) of the low refractive index sublayer; and λ is a wavelength ranging from 500 to 550 nm.

The low refractive index sublayer preferably contains a fluoropolymer as a low refractive index binder. The fluoropolymer is preferably a polymer crosslinked on application of heat or an ionizing radiation and having a dynamic frictional coefficient of 0.03 to 0.20, a contact angle with water of 90° to 1200, a pure water droplet sliding angle of 70° or smaller. Considering that a commercially available adhesive tape or label applied to the antireflective layer of an image display is desirably stripped off easily, the adhesive strength of the low refractive index sublayer to a commercially available pressure-sensitive adhesive tape is preferably 500 gf or less, more preferably 300 gf or less, even more preferably 100 gf or less. To secure scratch resistance, the low refractive index sublayer preferably has a surface hardness of 0.3 GPa or higher, still preferably 0.5 GPa or higher, measured with a microhardness meter.

Examples of the fluoropolymer include one obtained by hydrolysis followed by dehydration condensation of a perfluoroalkyl-containing silane compound (e.g., heptadecafluoro-1,1,2,2-tetrahydrodecyl)triethoxysilane) and a fluorine-containing copolymer containing a fluoromonomer unit and a monomer unit providing crosslinkability.

Examples of the fluoromonomer include fluoroolefins (e.g., fluoroethylene, vinylidene fluoride, tetrafluoroethylene, perfluorooctylethylene, hexafluoropropylene, and perfluoro-2,2-dimethyl-1,3-dioxole), partially or completely fluorinated alkyl ester derivatives of (meth)acrylic acid (e.g., Viscoat 6FM available from Osaka Organic Chemical Industry, Ltd. and M-2000 available from Daikin Industries, Ltd.), and partially or completely fluorinated vinyl ethers. Perfluoroolefins are preferred. Hexafluoropropylene is particularly preferred for its refractive index, solubility, transparency, and availability.

The units for providing crosslinkability include those derived from monomers having self-crosslinking functionality, such as glycidyl(meth)acrylate and glycidyl vinyl ether; those derived from monomers containing a carboxyl group, a hydroxyl group, an amino group, a sulfo group, etc., such as (meth)acrylic acid, methylol (meth)acrylate, hydroxyalkyl(meth)acrylate, allyl acrylate, hydroxyethyl vinyl ether, hydroxybutyl vinyl ether, maleic acid, and crotonic acid; and those resulting from incorporating a crosslinking functional group (e.g., (meth)acryloyl group) into the above-recited unit through polymer reaction (for example by causing acryl chloride to react on a hydroxyl group).

The fluorine-containing copolymer may further comprise, in addition to the fluoromonomer unit and the unit providing crosslinkability, a fluorine-free monomer unit to improve solvent solubility and transparency. Examples of such additional monomers include, but are not limited to, olefins (e.g., ethylene, propylene, isoprene, vinyl chloride and vinylidene chloride), acrylic esters (e.g., methyl acrylate, ethyl acrylate, and 2-ethylhexyl acrylate), methacrylic esters (e.g., methyl methacrylate, ethyl methacrylate, butyl methacrylate, and ethylene glycol dimethacrylate), styrene derivatives (e.g., styrene, divinylbenzene, vinyltoluene, and α-methylstyrene), vinyl ethers (e.g., methyl vinyl ether, ethyl vinyl ether, and cyclohexyl vinyl ether), vinyl esters (e.g., vinyl acetate, vinyl propionate, and vinyl cinnamate), acrylamides (e.g., N-t-butylacrylamide and N-cyclohexylacrylamide), methacrylamides, and acrylonitrile derivatives. A curing agent may be added appropriately to the above-described polymers as proposed in JP-A-10-25388 and JP-A-10-147739.

The light scattering sublayer is provided usually for the purpose of endowing the film with light diffusing properties by surface scattering and/or internal scattering and hard coat properties to improve scratch resistance. Therefore, the light scattering sublayer comprises a binder for developing hard coat properties, matte particles for developing light scattering properties, and, if desired, an inorganic filler for increasing the refractive index, preventing shrinkage on crosslinking, and increasing the strength. The light scattering sublayer preferably has a thickness of 1 to 10 μm, still preferably 1.2 to 6 μm, to secure hard coat properties and to prevent curling and embrittlement.

The binder of the light scattering sublayer is preferably a polymer having a saturated hydrocarbon main chain or a polyether main chain, more preferably a polymer having a saturated hydrocarbon main chain. The binder polymer preferably has a crosslinked structure. The binder polymer having a saturated hydrocarbon main chain is preferably a polymer of an ethylenically unsaturated monomer. The binder polymers having a saturated hydrocarbon main chain and a crosslinked structure preferably include homo- or copolymers of a monomer containing two or more ethylenically unsaturated groups. These monomers may have an aromatic ring or at least one atom selected from a halogen atom except fluorine, a sulfur atom, a phosphorus atom, and a nitrogen atom to provide a binder polymer with an increased refractive index.

Examples of the monomer containing two or more ethylenically unsaturated groups include esters of polyhydric alcohols and (meth)acrylic acid, such as ethylene glycol di(meth)acrylate, butanediol di(meth)acrylate, hexanediol di(meth)acrylate, 1,4-cyclohexanediacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate, and polyester polyacrylate; ethylene oxide-modified products of the above esters; vinylbenzene and its derivatives, such as 1,4-divinylbenzene, 2-acryloylethyl 4-vinylbenzoate, and 1,4-divinylcyclohexanone; vinylsulfones (e.g., divinylsulfone); acrylamides (e.g., methylenebisacrylamide); and methacrylamides. These monomers may be used as a combination of two or more thereof.

The monomers affording a high refractive index include bis(4-methacryloylthiophenyl)sulfide, vinylnaphthalene, vinyl phenyl sulfide, and 4-methacryloxyphenyl-4′-methoxyphenyl thioether. These monomers may also be used as a combination of two or more thereof.

Polymerization of the ethylenically unsaturated group-containing monomer(s) can be conducted by, for example, applying an ionizing radiation or heat in the presence of a photo radical initiator or a thermal radical initiator. Accordingly, the light scattering sublayer is formed by applying a coating composition containing the ethylenically unsaturated group-containing monomer(s), a photo or thermal radical initiator, matte particles, and an inorganic filler to the protective film and curing the coating layer by radiation- or heat-induced polymerization. Known photo radical initiators and thermal radical initiators can be used.

The polymer having a polyether main chain is preferably a ring opening polymerization product of a polyfunctional epoxy compound. Ring opening polymerization of a polyfunctional epoxy compound is effected by applying an ionizing radiation or heat in the present of a photo-acid generator or a thermal acid generator. Accordingly, the light scattering sublayer can be formed by applying a coating composition containing the polyfunctional epoxy compound, a photo-acid generator or a thermal acid generator, matte particles, and an inorganic filler to the protective film and curing the coating layer by ionizing radiation- or heat-induced polymerization.

A monomer having a crosslinking functional group may be used in place of, or in addition to, the monomer having two or more ethylenically unsaturated groups to make a polymer containing the crosslinking functional group, which is then allowed to react to introduce a crosslinked structure into the binder polymer.

Examples of the crosslinking functional group include an isocyanate group, an epoxy group, an aziridine group, an oxazoline group, an aldehyde group, a carbonyl group, a hydrazine group, a carboxyl group, a methylol group, and an active methylene group. Also included in monomers capable of introducing a crosslinked structure are vinyl sulfonic acids, acid an hydrides, cyanoacrylate derivatives, melamine, etherified methylols, esters, urethanes, and metal alkoxides such as tetramethoxysilane. A functional group that decomposes to develop crosslinkability, such as a blocked isocyanate group, is also useful. That is, the crosslinking functional group as referred to herein includes not only a ready-to-react one but a group that decomposes to become ready to crosslink. The binder polymer containing such a crosslinking functional group forms a crosslinked structure on being heated after the coating composition is applied.

The matte particles that are preferably used in the light scattering sublayer for imparting antiglare properties are greater than filler particles and usually have an average particle size of 1 to 10 μm, preferably 1.5 to 7.0 μm. Inorganic compound particles or resin particles are preferably used.

Examples of matte particles include particles of inorganic compounds, such as silica and titanium dioxide, and particles of resins, such as acrylic resins, crosslinked acrylic resins, polystyrene, crosslinked polystyrene, melamine resins, and benzoguanamine resins. Preferred of them are particles of crosslinked styrene, crosslinked acrylic resins, crosslinked acrylic styrene resins, and silica. The shape of the matte particles may be either spherical or irregular.

Two or more kinds of matte particles different in particle size may be used in combination. It is expected that larger particles contribute to non-glare while smaller particles serve for other optical characteristics.

It is particularly desirable that the matte particles have a mono-dispersed particle size distribution. In other words, it is preferred that the matte particles be as close to each other as possible in particle diameter. Particles whose size is 20% or more greater than the mean particle size being defined as coarse particles, the proportion of such coarse particles in all the particles is preferably 1% or smaller, more preferably 0.1% or smaller, even more preferably 0.01% or smaller. Matte particles with such a narrow size distribution are prepared by classifying particles as synthesized in a usual manner. An increased number of times of classification and/or an increased degree of classification result in a narrower and thus more desirable size distribution.

The matte particles are preferably used in an amount of 10 to 1000 mg/m², still preferably 100 to 700 g/m², in the light scattering sublayer.

The particle size distribution of the matte particles is measured with a Coulter counter. The measured distribution is converted to a number distribution.

In order to increase the refractive index of the light scattering sublayer, the light scattering sublayer preferably contains, as an inorganic filler, an oxide of at least one metal selected from titanium, zirconium, aluminum, indium, zinc, tin, and antimony having an average particle size of 0.2 μm or less, more preferably 0.1 μm or less, even more preferably 0.06 μm or less.

Where matte particles having a high refractive index are used, it is a preferred manipulation to use, as a filler, a silicon oxide largely different in refractive index from the matte particles thereby to somewhat reduce the refractive index of the light scattering sublayer to the contrary. The above-described preference for the particle size of inorganic fillers applies to the silicon oxide particles.

Examples of the inorganic fillers useful in the light scattering sublayer include TiO₂, ZrO₂, Al₂O₃, In₂O₃, ZnO, SnO₂, Sb₂O₃, ITO, and SiO₂. TiO₂ and ZrO₂ are preferred for increasing the refractive index. The inorganic filler may be surface treated with a silane coupling agent or a titan coupling agent. A surface treating agent having a functional group reactive with a binder species is preferably used.

The amount of the inorganic filler to be added is preferably 10% to 90%, more preferably 20% to 80%, even more preferably 30% to 75%, based on the total weight of the light scattering sublayer. The filler with the recited particle size is small enough as compared with light wavelengths and therefore does not cause light scattering. A disperse system of such a filler in a binder polymer behaves as an optically homogeneous substance.

The refractive index of the bulk of a mixture of the binder and the inorganic filler in the light scattering sublayer is preferably 1.48 to 2.00, more preferably 1.50 to 2.00, even more preferably 1.50 to 1.80, which can be achieved by proper selection of the kinds and the ratio of the binder and the inorganic filler. The selection can easily be decided experimentally.

The coating composition for forming the light scattering sublayer preferably contains a fluorine-containing surface active agent and/or a silicone surface active agent to prevent coating unevenness, drying unevenness and spot defects thereby securing uniformity of the surface properties. A fluorine-containing surface active agent is particularly preferred for its capability of reducing coating unevenness, drying unevenness, spot defects, and like coating defects with a reduced amount of addition. By use of the surface active agent, coating defects can be reduced, which allows high-speed coating and eventually leads to increased productivity.

The antireflective layer having a medium refractive index sublayer, a high refractive index sublayer, and a low refractive index sublayer stacked in that order from the protective film side is then described.

The antireflective layer having at least a medium refractive index sublayer, a high refractive index sublayer, and a low refractive index sublayer (the outermost layer) stacked in that order from the protective film side is preferably designed to satisfy the following relation: refractive index of the high refractive index sublayer>refractive index of the medium refractive index sublayer>refractive index of the protective film>refractive index of the low refractive index sublayer.

A hard coat sublayer may be provided between the protective film and the medium refractive index sublayer. The antireflective layer may have a hard coat sublayer having a medium refractive index, a high refractive index sublayer, and a low refractive index sublayer stacked in that order from the protective film side. Antireflective layer designs that can be used in the invention are described, e.g., in JP-A-8-122504, JP-A-8-110401, JP-A-10-300902, JP-A-2002-243906, and JP-A-2002-111706. Each of the sublayers may have an additional function. For instance, the low refractive index sublayer may be designed to have stain proof properties, or the high refractive index sublayer may be designed to have antistatic properties. For the details, reference can be made to JP-A-10-206603 and JP-A-2002-243906.

The antireflective layer preferably has a haze of 5% or less, more preferably 3% or less, and a pencil hardness of H or higher, more preferably 2H or higher, even more preferably 3H or higher, measured in accordance with JIS K5400.

The medium refractive index sublayer and the high refractive index sublayer are each preferably a cured film containing at least ultrafine particles of an inorganic compound having a high refractive index and a mean particle size of 100 nm or smaller and a binder as a matrix.

Examples of the inorganic compound with a high refractive index include those having a refractive index of 1.65 or higher, preferably those having a refractive index of 1.9 or higher, such as oxides or complex oxides of Ti, Zn, Sb, Sn, Zr, Ce, Ta, La, In, etc.

Such ultrafine particles can be obtained by, for example, treating particles with a surface treating agent, such as a silane coupling agent (see JP-A-11-295503, JP-A-11-153703, and JP-A-2000-9908), an anionic compound or an organometallic coupling agent (see JP-A-2001-310432); forming a core/shell structure having a high refractive index particle as a core (see JP-A-2001-166104, JP-A-2001-310432); or using a specific dispersant (see JP-A-11-153703, U.S. Pat. No. 6,210,858, and JP-A-2002-2776069).

The matrix-forming binder includes known thermoplastic resins and known curing resins. A composition containing a polyfunctional compound having at least two radical-polymerizable and/or cation-polymerizable groups, a composition containing an organometallic compound having a hydrolyzable group or a partial condensation product thereof, or a mixture of these compositions is a preferred matrix material. Examples of such compositions are described in JP-A-2000-47004, JP-A-2001-315242, JP-A-2001-31871, and JP-A-2001-296401.

A cured film of a composition containing a colloidal metal oxide and a metal alkoxide which is obtained by hydrolysis followed by condensation of the metal alkoxide is also a preferred matrix. The film is disclosed, e.g., in JP-A-2001-293818.

The high refractive index sublayer usually has a refractive index of 1.70 to 2.20 and preferably has a thickness of 5 nm to 10 μm, more preferably 10 nm to 1 μm. The refractive index of the medium refractive index sublayer is adjusted so as to be between the refractive index of the low refractive index sublayer (hereinafter recited) and that of the high refractive index sublayer. The medium refractive index sublayer preferably has a refractive index of 1.50 to 1.70 and a thickness of 5 nm to 10 μm, more preferably 10 nm to 1 μm.

The low refractive index sublayer, which is formed on the high refractive index sublayer, preferably has a refractive index of 1.20 to 1.55, more preferably 1.30 to 1.50.

The low refractive index sublayer is preferably designed to be a scratch-resistant and stain proof outermost sublayer. To impart slip properties to the surface is an effective means of greatly improving scratch resistance, which can be achieved by applying a known thin film technique using a silicone compound or a fluorine-containing compound.

The fluorine-containing compound preferably has a refractive index of 1.35 to 1.50, more preferably 1.36 to 1.47. A fluorine-containing compound containing a crosslinking or polymerizable functional group and having a fluorine content of 35% to 80% by weight is preferred. Examples of such a fluorine-containing compound are given in JP-A-9-222503, paras. [0018]-[0026], JP-A-11-38202, paras. [0019]-[0030], JP-A-2001-40284, paras. [0027]-[0028], and JP-A-2000-284102.

The silicone compound is a polysiloxane compound preferably containing a curable functional group or a polymerizable functional group in the polymer chain thereof to form a crosslinked structure in the film. Examples include reactive silicones (e.g., Silaplane available from Chisso Corp.) and polysiloxanes having a silanol group at both terminals thereof (see, for example, JP-A-11-258403).

Crosslinking or polymerization of the fluorine-containing compound or silicone compound having a crosslinking or polymerizable group is preferably conducted by applying a coating composition for outermost sublayer containing the fluorine-containing compound or silicone compound, a polymerization initiator, a sensitizer, etc. to the high refractive index sublayer, etc. and applying light or heat to the coating layer either simultaneously with or after coating.

A sol-gel hardened film formed by condensation curing reaction between an organometallic compound, such as a silane coupling agent, and a silane coupling agent containing a specific fluorohydrocarbon group in the presence of a catalyst is also preferred. Examples of the latter silane coupling agent include polyfluoroalkyl-containing silane compounds or partial hydrolysis-condensation products thereof (e.g., the compounds described in JP-A-58-142958, JP-A-58-147483, JP-A-58-147484, JP-A-9-157582, and JP-A-11-106704) and silyl compounds having a perfluoroalkyl ether group, i.e., a fluorine-containing long chain (e.g., the compounds described in JP-A-2000-117902, JP-A-2001-48590, and JP-A-2002-53804).

In addition to the components described above, the low refractive index sublayer may contain other additives, such as a filler, a silane coupling agent, a slip agent, and a surface active agent. Examples of useful fillers include particles of inorganic compounds having a low refractive index and an average primary particle size of 1 to 150 nm, such as silicon dioxide (silica) and fluorine-containing compounds (e.g., magnesium fluoride, calcium fluoride, and barium fluoride), and fine organic particles described in JP-A-11-3820, paras. [0020]-[0038].

In the case where the low refractive index sublayer is provided below an outermost sublayer, the low refractive index sublayer may be formed by vapor phase film formation processes, such as vacuum evaporation, sputtering, ion plating or plasma-assisted CVD. Wet coating methods are preferred for economical considerations nevertheless.

The low refractive index sublayer preferably has a thickness of 30 to 200 nm, more preferably 50 to 150 nm, even more preferably 60 to 120 nm.

In addition to the antireflective layer, the polarizing plate of the present invention can have a hard coat layer, a forward scattering layer, a primer layer, an antistatic layer, an undercoating layer, a protective layer, and the like.

The hard coat layer is provided on the transparent protective film having the antireflective layer to give a physical strength to the protective film. It is preferably provided between the protective film (base film) and the high refractive index sublayer. The hard coat layer is preferably formed by crosslinking or polymerization of a photo- and/or heat-curing compound. The curing functional group of the curing compound is preferably a photopolymerizable functional group. An organometallic compound containing a hydrolyzable functional group is preferably an organic alkoxysilyl compound. Examples of useful compounds are the same as recited with respect to the high refractive index sublayer. Examples of useful compositions for forming the hard coat layer are given in JP-A-2002-144913, JP-A-2000-9908, and WO 00/46617.

The high refractive index sublayer can serve as a hard coat layer. In this case, it is preferable to form the hard coat layer by finely dispersing fine particles by using the technique described concerning the high refractive index sublayer.

The hard coat layer may contain particles having an average particle size of 0.2 to 10 μm to serve as an antiglare layer having an antiglare function.

The thickness of the hard coat layer can be appropriately designed depending on the use. The thickness of the hard coat layer preferably ranges from 0.2 to 10 μm, more preferably 0.5 to 7 μm.

The hard coat layer preferably has a pencil hardness of H or higher, more preferably 2H or higher, even more preferably 3H or higher, measured in accordance with JIS K5400. Furthermore, the hard coat layer preferably has as small Taber wear as possible in the Taber abrasion test specified in JIS K5400.

Where an antistatic layer is provided, it is desirable to impart electrical conductivity represented by a volume resistivity of 10⁻⁸ (Ωcm⁻³) or less. Although volume resistivity could be reduced to 10⁻⁸ (Ωcm⁻³) or less by using a hygroscopic substance, a water-soluble inorganic salt, a certain surface active agent, a cationic polymer, an anionic polymer, colloidal silica, etc., the volume resistivity of the resulting layer is heavily dependent on temperature and humidity and, as a result, the layer can fail to secure sufficient conductivity under a low humidity condition. Therefore, it is advisable to use a metal oxide as an antistatic layer material. Colored metal oxides are unfavorable because they would make the whole film colored. It is recommended to use colorless metal oxides mainly composed of at least one of Zn, Ti, Sn, Al, In, Si, Mg, Ba, Mo, W, and V. Examples of suitable metal oxides include ZnO, TiO₂, SnO₂, Al₂O₃, In₂O₃, SiO₂, MgO, BaO, MoO₃, V₂O₅, and complex oxides thereof. In particular, ZnO, TiO₂, and SnO₂ are preferred. The metal oxide may be doped with a hetero atom. Effective metal oxides doped with a hetero atom include ZnO doped with Al or In, SnO₂ doped with Sb, Nb or a halogen atom, and TiO₂ doped with Nb or Ta. A particulate or fibrous crystalline metal (e.g., titanium oxide) having the above described metal oxide adhered thereto is also useful, as described in JP-B-59-6235. While volume resistivity and surface resistivity, being different physical properties, are not easily compared, a volume resistivity of 10⁻⁸ (Ωcm⁻³) or less will be secured when the antistatic layer has a surface resistivity of about 10⁻¹⁰ (Ω/square) or less, preferably 10⁻⁸ (Ω/square) or less. The surface resistivity of the antistatic layer should be measured while the antistatic layer is outermost. Namely, the surface resistivity measurement of the antistatic layer is taken in the course of the formation of a stack of layers.

The LCD of the present invention having at least one of the above described cyclic polyolefin film, polarizer protective film, optical compensation film, and polarizing plate will be described.

The cyclic polyolefin film, the optical compensation film having the cyclic polyolefin film, and the polarizing plate having the cyclic polyolefin film according to the present invention are applicable to a wide range of display modes of liquid crystal cells and LCDs. Proposed LCD display modes include TN (twisted nematic), IPS (in-plane switching), FLC (ferroelectric liquid crystal), AFLC (anti-ferroelectric liquid crystal) OCB (optically compensatory bend), STN (supper twisted nematic), VA (vertically aligned), HAN (hybrid aligned nematic), and ECB (electrically controlled birefringence). Of these modes, IPS, ECB, OCB, and VA modes are preferred for application of the present invention.

The cyclic polyolefin film of the invention is particularly advantageously used as a substrate of the optical compensation film or a protective film of the polarizer in an IPS mode LCD having an IPS mode liquid crystal cell and an ECB mode LCD having an ECB mode liquid crystal cell. In these display modes, the liquid crystal molecules are aligned substantially parallel with the substrates in a black display state. That is, the liquid crystal molecules are in parallel with the substrates with no voltage applied to achieve a black display. The polarizer having the cyclic polyolefin film contributes to viewing angle enhancement and contrast improvement in IPS and ECB modes.

In a liquid crystal cell of OCB mode, rod-like liquid crystal molecules are aligned in a bend state (bend alignment) so that the molecules in one side of the cell and those in the other side are aligned substantially in the opposite direction (symmetrically). OCB mode liquid crystal cells are disclosed in U.S. Pat. Nos. 4,583,825 and 5,410,422. Since the bend alignment cell has the rod-like liquid crystal molecules aligned symmetrically at both sides thereof, it has a self compensation function. This is why the bend alignment mode is called “optically compensatory bend” mode. LCDs of bend alignment mode have an advantage of improved response time.

In a liquid crystal cell of VA mode, rod-like liquid crystal molecules are aligned substantially vertically with no voltage applied. Liquid crystal cells of VA mode include (1) a liquid crystal cell of VA mode in a narrow sense of the term, in which rod-like liquid crystal molecules are substantially vertically aligned with no voltage applied and substantially horizontally aligned with voltage applied (see JP-A-2-176625), (2) a liquid crystal cell of MVA mode, in which the VA mode is modified to be multi-domain type so as to widen the viewing angle (described in SID97, Digest of Tech. Papers, 28 (1997), p. 845), (3) a liquid crystal cell of n-ASM mode, in which rod-like liquid crystal molecules are substantially vertically aligned with no voltage applied and aligned in twisted multi-domain alignment with voltage applied (described in Nippon Ekisho Toronkai, Digest of Tech. Papers (1998), pp. 58-59), and (4) a liquid crystal cell of SURVIVAL mode (published in LCD international 98).

The VA mode LCD has a liquid crystal cell (VA mode cell) and a polarizing plate placed on each side of the cell. The liquid crystal cell holds a liquid crystal layer between two electrode plates.

In one embodiment of the transmissive LCD of the invention, the optical compensation film of the invention is placed between the liquid crystal cell and one of the polarizing plates or between the liquid crystal cell and each of the two polarizing plates.

In another embodiment of the transmission LCD according to the invention, the optical compensation film using the cyclic polyolefin film is used as a protective film provided between the liquid crystal cell and the polarizer. That is, the transparent protective film of the polarizing plat is capable of functioning as an optical compensation film. The optical compensation film can be used as a protective film of only one of the polarizing plates (the protective film positioned between the cell and the polarizer) or as a protective film of both of the two polarizing plates (the protective film positioned between the cell and each of the polarizers). When the optical compensation film is used in only one of the polarizing plates, it is preferably used as the liquid crystal cell side protective film of the backlight side polarizer. The polarizing plate is preferably adhered to the liquid crystal cell with the cyclic polyolefin film of the invention facing the VA mode liquid crystal cell. The other protective film may be a cellulose acylate film ordinarily employed in the art. Cellulose acylate films having a thickness of 40 to 80 μm are preferred. Examples of commercially available cellulose acylate films that can be used as a protective film include, but are not limited to, KC4UX2M (thickness: 40 μm; available from Konica Opto Corp.), KC5UX (thickness: 60 μm; from Konica Opto Corp.) and TD80 (thickness: 80 μm; available from Fuji Photo Film Co., Ltd.).

An optical compensation film is used in OCB mode LCDs and TN mode LCDs for viewing angle enhancement. For application to OCB mode cells, an optical compensation film comprising an optically uniaxial or biaxial film and an optically anisotropic layer formed thereon is used. The optically anisotropic layer is formed by fixing discotic liquid crystal molecules in a hybrid alignment. For application to TN mode cells, an optical compensation film comprising an optically isotropic or a film having an optical axis in its thickness direction and an optically anisotropic layer formed thereon is used. The optically anisotropic layer is formed by fixing discotic liquid crystal molecules in a hybrid alignment. The cyclic polyolefin film of the invention is useful in the formation of such optical compensation films for the OCB mode cells and TN mode cells.

### EXAMPLES

The present invention will now be illustrated in greater detail with reference to Examples, but it should be understood that the invention is not construed as being limited thereto. Unless otherwise noted, all the parts and percents are by weight.

### Synthesis Example 1

### Synthesis of Cyclic Polyolefin P-1

In a reaction vessel were put 100 parts of purified toluene and 100 parts of methyl norbornenecarboxylate. To the mixture were added a toluene solution containing 25 mmol %, based on the weight of the monomer, of nickel ethylhexanoate, 0.225 mol %, based on the weight of the monomer, of tri(pentafluorophenyl)boron, and a toluene solution containing 0.25 mol %, based on the weight of the monomer, of triethylaluminum. The mixture was allowed to react at room temperature for 18 hours while stirring. After completion of the reaction, the reaction mixture was poured into excess ethanol to precipitate the polymer produced, which was collected, purified, and dried in vacuo at 65° C. for 24 hours to yield cyclic polyolefin, designated P-1.

The resulting polymer was found to have a polystyrene equivalent number average molecular weight of 79,000 and a polystyrene equivalent weight average molecular weight of 205,000 as a result of GPC (in tetrahydrofuran) and a refractive index of 1.52 measured with an Abbe refractometer.

### Synthesis Example 2

### Synthesis of Retardation Rth(λ) Decreasing Agent

Synthesis of A

In a 1 L three-necked flask equipped with a mechanical stirrer, a thermometer, a reflux condenser, and a dropping funnel were put 41.0 g of aniline and 400 ml of acetonitrile. While cooling with ice, 38.1 g of powdery p-toluenesulfonyl chloride was added and the resultant mixture was allowed to react at 70° C. for 2 hours. After ceasing the reaction by adding 350 ml of water, the reaction mixture was separated/extraction with 500 ml of ethyl acetate. The resulting organic layer was washed twice with 1N hydrochloric acid and a saturated sodium chloride aqueous solution, dehydrated over anhydrous magnesium sulfate, and concentrated to give a white solid. The white solid was dried under a hot air stream at 50° C. to thereby give 49 g of the target compound A (yield: 99%).

Synthesis of B

In a 500 ml three-necked flask equipped with a mechanical stirrer, a thermometer, a reflux condenser, and a dropping funnel were put 30.3 g of Monol, 18.7 g of triethylamine and 100 ml of THF. While cooling with ice, 25.5 g of benzoyl chloride was added and the resultant mixture was refluxed for 6 hours. When 500 ml of water was added to the reaction mixture, grayish brown crystals were precipitated. The crystals were collected by filtration and washed with 1 N hydrochloric acid and a saturated sodium chloride aqueous solution. The grayish brown crystals thus obtained were dried under a hot stream at 50° C. to thereby give 34.5 g of an intermediate 1 (yield: 86%).

In a 500 ml three-necked flask equipped with a mechanical stirrer, a thermometer, a reflux condenser, and a dropping funnel were put 20.0 g of the above-described intermediate 1, 8.2 g of 1,2-bis(2-chloroethoxy)ethane, 24.3 g of potassium carbonate and 100 ml of dimethylacetamide and the resultant mixture was stirred at 100° C. for 10 hours. After the completion of the reaction, the mixture was returned to room temperature and separated/extracted with 500 ml of ethyl acetate. The resulting organic layer was washed twice with 1 N hydrochloric acid and a saturated sodium chloride aqueous solution, dehydrated over anhydrous magnesium sulfate, and concentrated to give a brown oily matter. The brown oily matter thus obtained was vacuum dried at room temperature to thereby give 24.7 g of the target compound B (yield: 98%).

Synthesis of C

In a 1 L three-necked flask equipped with a mechanical stirrer, a thermometer, a reflux condenser, and a dropping funnel were put 106.0 g of N-methyl aniline, 78.3 g of pyridine and 800 ml of acetonitrile. While cooling with ice, a solution prepared by dissolved 79.6 g of trimesic acid chloride in 30 ml of acetonitrile was added dropwise. Next, the resultant mixture was returned to room temperature and allowed to react at room temperature for 2 hours. When 350 ml of methanol was added to the reaction mixture followed by stirring at room temperature for 30 minutes, white crystals were precipitated. The white crystals were collected by filtration, washed with a large amount of methanol and dried under a hot air stream at 50° C. to thereby give 128 g of the target compound C (yield: 89%).

Synthesis of D

In a 500 ml three-necked flask equipped with a mechanical stirrer, a thermometer, a reflux condenser, and a dropping funnel were put 12.5 g of N-methylcyclohexylamine, 11.2 g of triethylamine and 100 ml of THF. While cooling with ice, 10.1 g of phthalic acid chloride was added. Then, the reaction mixture was returned to room temperature and allowed to react at room temperature for 2 hours. After adding 300 ml of water, the reaction mixture was separated/extraction with 300 ml of ethyl acetate. The resulting organic layer was washed twice with 1 N hydrochloric acid and a saturated sodium chloride aqueous solution, dehydrated over anhydrous magnesium sulfate, and concentrated to give a white solid. The white solid was vacuum dried at room temperature to thereby give 16.2 g of the target compound D (yield: 91%).

Synthesis of E

In a 500 ml three-necked flask equipped with a mechanical stirrer, a thermometer, a Dean-Stark trap, and a dropping funnel were put 38.4 g of citric acid, 71.5 g of methyl amyl alcohol and 200 ml of toluene. Then, the mixture was stirred at room temperature to give a solution of the mixture. After slowly adding 5 ml of conc. sulfuric acid to the solution, the mixture was heated under reflux and allowed to react until no water was distilled any more. After adding 10 g of calcium carbonate to the residue, the reaction system was concentrated as such with the use of an aspirator to give an oily product. The obtained oily product was dissolved in 500 ml of ethyl acetate and separated/washed successively with 500 ml of water and 500 ml of a saturated aqueous sodium bicarbonate solution each twice. The resulting organic layer was dehydrated over magnesium sulfate. After filtering off the magnesium sulfate, the filtrate was concentrated on an evaporator and further vacuum dried at room temperature to thereby give 70.0 g of the target compound E (yield: 78.0%).

### Example 1

The following components were agitated in a mixing tank to dissolve. The solution was filtered through a filter paper having an average pore size of 34 μm and a sintered metal filter having an average pore size of 10 μm to prepare a film-forming dope.

| | |
|---|---|
| P-1 | 100 parts |
| Dichloromethane | 325 parts |
| Methanol | 28.5 parts |

The dope was cast on a belt casting machine. When the residual solvent content dropped to about 30%, the cast film was peeled off the belt and dried in a tenter charged with hot air at 140° C. The film released from the tenter was further dried at 120° to 140° C. while being conveyed on carrying rolls and wound into roll. The resulting film, designated film F-1, had a width of 1440 mm and a thickness of 25 μm.

### Example 2

A cyclic polyolefin film, designated film F-2, was obtained in the same manner as in Example 1, except that the cast film was stretched in the transverse direction at a stretch ratio of 12% by means of a tenter and then relaxed at 140° C. for 60 seconds to a transverse stretch ratio of 10%. The resulting film had a thickness of 25 μm.

### Example 3

A cyclic polyolefin film, designated film F-3, was obtained in the same manner as in Example 1, except for somewhat increasing the casting flow rate so as to result in a final film thickness of 40 μm.

### Example 4

A cyclic polyolefin film, designated film F-4, was obtained in the same manner as in Example 2, except that the casting flow rate was somewhat increased to obtain a cast film with a thickness of about 47 μm and that the cast film was transversely stretched to a final stretch ratio of 15% so as to result in a final film thickness of 40 μm.

### Example 5

A cyclic polyolefin film, designated film F-5, was obtained in the same manner as in Example 1, except for somewhat increasing the casting flow rate so as to result in a final film thickness of 50 μm.

### Example 6

A cyclic polyolefin film, designated film F-6, was obtained in the same manner as in Example 4, except for somewhat increasing the casting flow rate so as to result in a final film thickness of 50 μm.

### Example 7

A cyclic polyolefin film, designated film F-7, was obtained in the same manner as in Example 1, except for somewhat increasing the casting flow rate so as to result in a final film thickness of 60 μm.

### Example 8

A cyclic polyolefin film, designated film F8, was obtained in the same manner as in Example 4, except for somewhat increasing the casting flow rate so as to result in a final film thickness of 60 μm.

### Example 9

A cyclic polyolefin film, designated film F-9, was obtained in the same manner as in Example 1, except for adding 10% of the Rth(λ) decreasing agent A to the formulation of the dope. Examples 10 to 85 and Comparative Examples 1 to 8

Cyclic polyolefin films, designated F-10 to F-85 and H-1 to H-8, were obtained in the same manner as in Example 1 or 2 except for the alterations shown in Tables 1 to 3 below. The thickness of the resulting films is shown in Tables 1 to 3.

The resulting films were evaluated for optical characteristics (Re and Rth), humidity dependence of optical characteristics, moisture permeability, and adhesion to a polarizer in accordance with the methods below. The results of evaluations are also shown in Tables 1 to 3.

(1) Optical Characteristics

Re and Rth were measured using KOBRA 21ADH (from Oji Scientific Instruments).

(2) Humidity Dependence

The film was conditioned at 25° C. and 10% RH and at 25° C. and 80% RH each for 24 hours and then measured for Re and Rth as described above. The absolute difference between the Re or Rth measured after conditioning at 10% RH and the Re or Rth measured after conditioning at 80% RH was obtained as a measure for humidity dependence of Re and Rth.

(3) Moisture Permeability

A disk specimen of 70 mm in diameter was conditioned at 40° C. and 90% RH for 24 hours and then measured for water content per unit area (g/m²·day) using a moisture permeability tester (KK-709007 from Toyo Seiki Seisaku-sho, LTD.) in accordance with JIS Z0208. The difference in weight between before and after the humidity conditioning was taken as moisture permeability.

(4) Adhesion to Polarizer

The film formed on a polarizer was subjected to cross-cut scotch tape test in accordance with JIS K5600 (1999). The adhesion was rated A (0 to 5 squares removed), B (5 to 15 squares removed) or C (removal over almost the entire area).

TABLE 1

| | | | | Additive | | | | | | | | |
|---|---|---|---|---|---|---|---|---|---|---|---|---|
| | | | | (Rth | Addition | Stretch | Optical | Humidity | | | Moisture | Adhesion |
| | | | Thickness | decreasing | level | Ratio | properties | Dependence | | | Permeability | to |
| | | Polymer | (μm) | gent) | (%) | (%) | Re | Rth | ΔRe | ΔRth | (g/m²/day) | Polarizer |
| Example | 01 | P-1 | 25 | no | 0 | 0 | 10 | 80 | 2.1 | 6.7 | 834 | A |
| | 02 | P-1 | 25 | no | 0 | 10 | 40 | 110 | 3.8 | 7.8 | 843 | A |
| | 03 | P-1 | 40 | no | 0 | 0 | 14 | 122 | 1.7 | 4.6 | 578 | A |
| | 04 | P-1 | 40 | no | 0 | 15 | 47 | 197 | 2.0 | 6.0 | 570 | A |
| | 05 | P-1 | 50 | no | 0 | 0 | 20 | 148 | 0.6 | 1.2 | 503 | A |
| | 06 | P-1 | 50 | no | 0 | 15 | 55 | 221 | 1.2 | 2.3 | 585 | A |
| | 07 | P-1 | 60 | no | 0 | 0 | 18 | 175 | 0.1 | 2.1 | 402 | A |
| | 08 | P-1 | 60 | no | 0 | 15 | 75 | 253 | 2.1 | 1.3 | 435 | A |
| | 09 | P-1 | 25 | A | 10 | 0 | 8 | 32 | 2.0 | 6.9 | 902 | A |
| | 10 | P-1 | 25 | A | 10 | 10 | 38 | 48 | 3.5 | 7.9 | 954 | A |
| | 11 | P-1 | 40 | A | 10 | 0 | 11 | 55 | 1.6 | 4.4 | 567 | A |
| | 12 | P-1 | 40 | A | 10 | 15 | 42 | 123 | 1.8 | 5.9 | 503 | A |
| | 13 | P-1 | 50 | A | 10 | 0 | 20 | 92 | 0.5 | 1.5 | 432 | A |
| | 14 | P-1 | 50 | A | 10 | 15 | 50 | 158 | 1.3 | 2.8 | 402 | A |
| | 15 | P-1 | 60 | A | 10 | 0 | 16 | 110 | 1.3 | 2.5 | 401 | A |
| | 16 | P-1 | 60 | A | 10 | 15 | 65 | 184 | 1.3 | 5.1 | 421 | A |
| | 17 | P-1 | 25 | A | 20 | 0 | 8 | 21 | 2.2 | 6.5 | 729 | A |
| | 18 | P-1 | 25 | A | 20 | 10 | 37 | 28 | 3.5 | 7.8 | 711 | A |
| | 19 | P-1 | 40 | A | 20 | 0 | 12 | 35 | 1.8 | 4.4 | 602 | A |
| | 20 | P-1 | 40 | A | 20 | 15 | 40 | 42 | 2.3 | 5.3 | 577 | A |
| | 21 | P-1 | 50 | A | 20 | 0 | 17 | 50 | 0.8 | 1.5 | 529 | A |
| | 22 | P-1 | 50 | A | 20 | 15 | 51 | 101 | 1.4 | 2.0 | 528 | A |
| | 23 | P-1 | 60 | A | 20 | 0 | 17 | 75 | 1.0 | 2.1 | 529 | A |
| | 24 | P-1 | 60 | A | 20 | 15 | 60 | 158 | 2.1 | 2.0 | 528 | A |
| | 25 | P-1 | 60 | B | 20 | 0 | 1 | 140 | 2.2 | 6.5 | 450 | A |
| | 26 | P-1 | 60 | B | 30 | 0 | 2 | 95 | 3.5 | 7.8 | 205 | A |
| | 27 | P-1 | 60 | C | 20 | 0 | 1 | 152 | 1.8 | 4.4 | 540 | A |
| | 28 | P-1 | 60 | C | 30 | 0 | 5 | 101 | 2.3 | 5.3 | 210 | A |
| | 29 | P-1 | 60 | D | 20 | 0 | 4 | 155 | 0.6 | 1.2 | 502 | A |
| | 30 | P-1 | 60 | D | 30 | 0 | 3 | 102 | 1.2 | 2.3 | 206 | A |
| | 31 | P-1 | 60 | E | 20 | 0 | 2 | 141 | 2.0 | 6.9 | 469 | A |
| | 32 | P-1 | 60 | E | 30 | 0 | 1 | 95 | 3.5 | 7.9 | 226 | A |
| | 33 | P-1 | 60 | F | 20 | 0 | 5 | 134 | 1.6 | 4.4 | 560 | A |
| | 34 | P-1 | 60 | F | 30 | 0 | 4 | 80 | 1.8 | 5.9 | 210 | A |

TABLE 2

| | | | | Additive | | | | | | | | |
|---|---|---|---|---|---|---|---|---|---|---|---|---|
| | | | | (Rth | Addition | Stretch | Optical | Humidity | | | Moisture | Adhesion |
| | | | Thickness | decreasing | level | Ratio | properties | Dependence | | | Permeability | to |
| | | Polymer | (μm) | gent) | (%) | (%) | Re | Rth | ΔRe | ΔRth | (g/m²/day) | Polarizer |
| Example | 35 | P-1 | 60 | G | 20 | 0 | 2 | 135 | 0.5 | 1.5 | 540 | A |
| | 36 | P-1 | 60 | G | 30 | 0 | 3 | 82 | 0.6 | 1.2 | 210 | A |
| | 37 | P-1 | 60 | H | 20 | 0 | 4 | 134 | 1.2 | 2.3 | 574 | A |
| | 38 | P-1 | 60 | H | 30 | 0 | 5 | 81 | 2.0 | 6.9 | 201 | A |
| | 39 | P-1 | 60 | I | 20 | 0 | 1 | 164 | 3.5 | 7.9 | 604 | A |
| | 40 | P-1 | 60 | I | 30 | 0 | 2 | 118 | 1.6 | 4.4 | 205 | A |
| | 41 | P-1 | 60 | J | 20 | 0 | 0 | 170 | 1.8 | 5.9 | 610 | A |
| | 42 | P-1 | 60 | J | 30 | 0 | 1 | 121 | 0.5 | 1.5 | 240 | A |
| | 43 | P-1 | 60 | K | 20 | 0 | 2 | 167 | 3.5 | 2.0 | 520 | A |
| | 44 | P-1 | 60 | K | 30 | 0 | 3 | 124 | 1.8 | 3.5 | 215 | A |
| | 45 | P-1 | 60 | L | 20 | 0 | 5 | 145 | 2.3 | 1.6 | 546 | A |
| | 46 | P-1 | 60 | L | 30 | 0 | 2 | 103 | 0.6 | 1.8 | 231 | A |
| | 47 | P-1 | 60 | M | 20 | 0 | 1 | 153 | 1.2 | 0.5 | 546 | A |
| | 48 | P-1 | 60 | M | 30 | 0 | 1 | 105 | 2.0 | 1.3 | 231 | A |
| | 49 | P-1 | 60 | N | 20 | 0 | 2 | 128 | 3.5 | 2.2 | 512 | A |
| | 50 | P-1 | 60 | N | 30 | 0 | 2 | 78 | 1.6 | 3.5 | 221 | A |
| | 51 | P-1 | 60 | O | 20 | 0 | 1 | 148 | 1.8 | 1.8 | 451 | A |
| | 52 | P-1 | 60 | O | 30 | 0 | 0 | 112 | 3.5 | 7.9 | 214 | A |
| | 53 | P-1 | 60 | P | 20 | 0 | 0 | 122 | 1.6 | 4.4 | 496 | A |
| | 54 | P-1 | 60 | P | 30 | 0 | 3 | 75 | 1.8 | 5.9 | 211 | A |
| | 55 | P-1 | 60 | Q | 20 | 0 | 6 | 125 | 0.5 | 1.5 | 546 | A |
| | 56 | P-1 | 60 | Q | 30 | 0 | 5 | 76 | 1.3 | 2.8 | 231 | A |
| | 57 | P-1 | 60 | R | 20 | 0 | 4 | 138 | 2.2 | 6.5 | 512 | A |
| | 58 | P-1 | 60 | R | 30 | 0 | 4 | 98 | 3.5 | 7.8 | 205 | A |
| | 59 | P-1 | 60 | S | 20 | 0 | 2 | 145 | 1.8 | 4.4 | 610 | A |
| | 60 | P-1 | 60 | S | 30 | 0 | 5 | 92 | 2.3 | 5.3 | 240 | A |
| | 61 | P-1 | 60 | T | 20 | 0 | 2 | 148 | 0.8 | 1.5 | 520 | A |
| | 62 | P-1 | 60 | T | 30 | 0 | 2 | 98 | 1.4 | 2.0 | 215 | A |
| | 63 | P-1 | 60 | U | 20 | 0 | 1 | 146 | 1.6 | 4.4 | 546 | A |
| | 64 | P-1 | 60 | U | 30 | 0 | 1 | 90 | 1.8 | 5.9 | 231 | A |
| | 65 | P-1 | 60 | V | 20 | 0 | 0 | 154 | 0.5 | 1.5 | 469 | A |
| | 66 | P-1 | 60 | V | 30 | 0 | 1 | 86 | 1.3 | 2.8 | 226 | A |
| | 67 | P-1 | 60 | W | 20 | 0 | 2 | 158 | 1.0 | 0.6 | 560 | A |
| | 68 | P-1 | 60 | W | 30 | 0 | 3 | 108 | 2.0 | 7.0 | 210 | A |

TABLE 3

| | | | | Additive | | | | | | | | |
|---|---|---|---|---|---|---|---|---|---|---|---|---|
| | | | | (Rth | Addition | Stretch | Optical | Humidity | | | Moisture | Adhesion |
| | | | Thickness | decreasing | level | Ratio | properties | Dependence | | | Permeability | to |
| | | Polymer | (μm) | agent) | (%) | (%) | Re | Rth | ΔRe | ΔRth | (g/m²/day) | Polarizer |
| Example | 69 | P-1 | 60 | X | 20 | 0 | 2 | 134 | 1.8 | 5.9 | 460 | A |
| | 70 | P-1 | 60 | X | 30 | 0 | 5 | 91 | 0.5 | 1.5 | 208 | A |
| | 71 | P-1 | 60 | Y | 20 | 0 | 2 | 146 | 1.3 | 2.8 | 540 | A |
| | 72 | P-1 | 60 | Y | 30 | 0 | 2 | 110 | 2.2 | 6.5 | 205 | A |
| | 73 | P-1 | 60 | Z | 20 | 0 | 1 | 136 | 3.5 | 7.8 | 468 | A |
| | 74 | P-1 | 60 | Z | 30 | 0 | 1 | 75 | 1.8 | 4.4 | 210 | A |
| | 75 | P-1 | 60 | AA | 20 | 0 | 0 | 145 | 2.3 | 5.3 | 571 | A |
| | 76 | P-1 | 60 | AA | 30 | 0 | 1 | 95 | 2.0 | 1.3 | 231 | A |
| | 77 | P-1 | 60 | AB | 20 | 0 | 2 | 154 | 3.5 | 2.2 | 487 | A |
| | 78 | P-1 | 60 | AB | 30 | 0 | 2 | 104 | 1.6 | 3.5 | 235 | A |
| | 79 | P-1 | 58 | Z | 30 | 5 | 14 | 81 | 1.3 | 2.8 | 234 | A |
| | 80 | P-1 | 55 | Z | 30 | 10 | 22 | 84 | 1.0 | 0.6 | 254 | A |
| | 81 | P-1 | 53 | Z | 30 | 15 | 24 | 87 | 2.0 | 7.0 | 265 | A |
| | 82 | P-1 | 51 | Z | 30 | 20 | 30 | 90 | 1.8 | 5.9 | 270 | A |
| | 83 | P-1 | 48 | Z | 30 | 25 | 45 | 93 | 0.5 | 1.5 | 284 | A |
| | 84 | P-1 | 45 | Z | 30 | 30 | 66 | 92 | 1.3 | 2.8 | 296 | A |
| | 85 | P-1 | 43 | Z | 30 | 35 | 72 | 92 | 1.5 | 4.1 | 315 | A |
| Comp. | 01 | P-1 | 15 | no | no | 0 | — | — | — | — | — | C |
| Example | 02 | P-1 | 15 | no | no | broken | — | — | — | — | — | C |
| | 03 | P-1 | 80 | no | no | 0 | 30 | 281 | 0.5 | 1.4 | 380 | B |
| | 04 | P-1 | 80 | no | no | 15 | 65 | 389 | 1.4 | 2.5 | 367 | B |
| | 05 | ZENOR | 80 | no | no | 0 | 0 | 1 | 0 | 0 | 0 | B |
| | 06 | ZENOR | 80 | no | no | 10 | 15 | 20 | 0 | 0 | 0 | C |
| | 07 | ARTON | 80 | no | no | 0 | 3 | 5 | 0 | 0 | 0 | C |
| | 08 | ARTON | 80 | no | no | 10 | 20 | 35 | 0 | 0 | 0 | C |

In Tables 1 to 3, ZENOR (registered trademark) employed in Comparative Examples 5 and 6 is a cyclic polyolefin available from Zeon Corp, while ARTON (registered trademark) employed in Comparative Examples 7 and 8 is a cyclic polyolefin available from JSR Corp.

The following structural formulae and Table 4 show the additives employed in Tables 1 to 3.

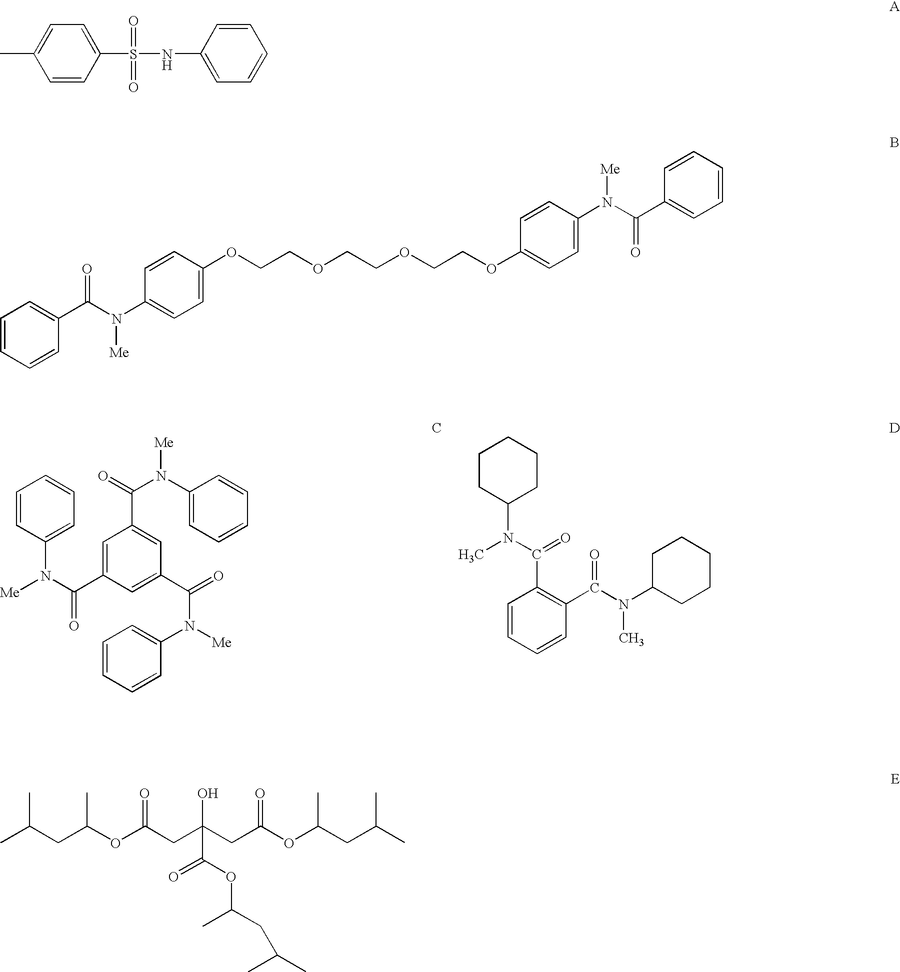

TABLE 4

| Rth | | | |
|---|---|---|---|
| decreasing | | | |
| agent | Manufacturer | Product name | Mw |
| F | Soken Chemical & | ACTFLOW UMM1001 | 1000 |
| | Engineering | | |
| G | Toa Gosei | ARUFON UP-1010 | 1700 |
| H | — | polymethyl methacrylate | 10000 |
| I | Aldrich | polystyrene | 800 |
| J | Aldrich | polystyrene | 2500 |
| K | Aldrich | polystyrene | 14000 |
| L | Aldrich | polystyrene-methacrylate | 130000 |
| | | (styrene/methacrylate = 40/60) | |
| M | Aldrich | poly(styrene-maleic anhydride) copolymer | 180000 |
| | | (styrene/maleic anhydride = 86/14) | |
| N | Toa Gosei | ARUFON UH-2041 | 2500 |
| O | Aldrich | poly(styrene-maleic anhydride) copolymer | |
| | | (partly propyl-esterified) | |
| P | Soken Chemical & | ACTFLOW CBB3098 | 2000 |
| | Engineering | | |
| Q | Soken Chemical & | ACTFLOW CB3098 | 2000 |
| | Engineering | | |
| R | Soken Chemical & | ACTFLOW AS301 | 1300 |
| | Engineering | | |
| S | Soken Chemical & | ACTFLOW UME2005 | 3500 |
| | Engineering | | |
| T | Nippon Steel Chemical | YXLON V120 | 730 |
| U | Toa Gosei | UH2180 | 8000 |
| V | Johnson Polymer | JOHNCRYL 586 | 5000 |
| W | Gifu Shellac | GSM301 | 3000 |
| X | | P + U (combined use of Rth decreasing agents P and U; | |
| | | 1:1 by mass) | |
| Y | | P + W 1:1 | |
| Z | | N + U 1:1 | |
| AA | | N + V 1:1 | |
| AB | | N + W 1:1 | |

This application is based on Japanese Patent application JP 2006-268716, filed Sep. 29, 2006, the entire content of which is hereby incorporated by reference, the same as if fully set forth herein.

Although the invention has been described above in relation to preferred embodiments and modifications thereof, it will be understood by those skilled in the art that other variations and modifications can be effected in these preferred embodiments without departing from the scope and spirit of the invention.

What is claimed is:

1. An optical film having a thickness of from 20 to 60 μm, comprising a cyclic olefin resin, and satisfying the following conditions (1) to (3):
0≦Re≦75 (1)
20≦Rth≦255 (2)
200≦D≦1000 (3)
where Re is an in-plane retardation at a wavelength of 590 nm; Rth is a retardation in a thickness direction at a wavelength of 590 nm; and D is a moisture permeability at 40° C. and 90% RH.

2. The optical film according to claim 1, satisfying following conditions (4) and (5):
ΔRe(25° C.,10% RH−25° C.,80% RH)≦4 (4)
ΔRth((25° C.,10% RH−25° C.,80% RH)≦8 (5)
where ΔRe (25° C., 10% RH−25° C., 80% RH) is a difference between the in-plane retardation at 590 nm after standing in an atmosphere of 25° C. and 10% RH for 24 hours and that after standing in an atmosphere of 25° C. and 80% RH for 24 hours; and ΔRth(25° C., 10% RH−25° C., 80% RH) is a difference between the thickness direction retardation at 590 nm after standing in an atmosphere of 25° C. and 10% RH for 24 hours and that after standing in an atmosphere of 25° C. and 80% RH for 24 hours.

3. The optical film according to claim 1, wherein the cyclic olefin resin comprises at least one polymer selected from the group consisting of (A-1) an addition copolymer comprising at least one repeating unit represented by the following formula (I): 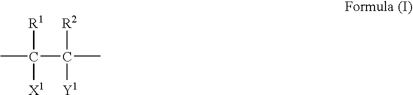
and at least one repeating unit represented by the following formula (II): 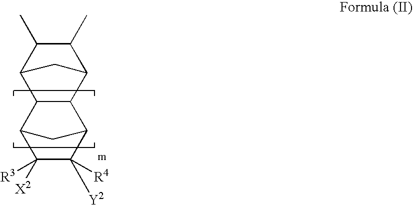
(A-2) an addition polymer comprising at least one repeating unit represented by the formula (II), and (A-3) a ring opening polymer comprising at least one repeating unit represented by the following formula (III): 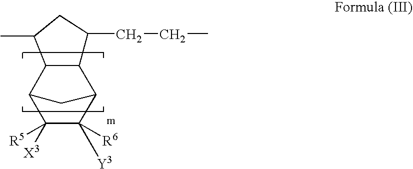
wherein m represents an integer of from 0 to 4; R¹, R², R³, R⁴, R⁵, and R⁶ each independently represent a hydrogen atom or a hydrocarbon group having from 1 to 10 carbon atoms; X¹, X², X³, Y¹, Y², and Y³ each independently represent a hydrogen atom, a hydrocarbon group having from 1 to 10 carbon atoms, a halogen atom, a halogen-substituted hydrocarbon group having from 1 to 10 carbon atoms, —(CH₂)ₙCOOR¹, —(CH₂)ₙOCOR¹²—(CH₂)ₙNCO, —(CH₂)ₙNO₂, —(CH₂)ₙCN, —(CH₂)ₙCONR¹³R¹⁴, —(CH₂)ₙNR¹³R¹⁴, —(CH₂)ₙOZ, or —(CH₂)ₙW; or X¹ and Y¹ are taken together, X² and Y² are taken together, or X³ and Y³ are taken together, each to form (—CO)₂O or (—CO)₂NR¹⁵; R¹¹, R¹², R¹³, R¹⁴, and R¹⁵ each independently represent a hydrogen atom or a hydrocarbon group having from 1 to 20 carbon atoms; Z represents a hydrocarbon group or a halogen-substituted hydrocarbon group; W represents SiR¹⁶ₚD₃₋ₚ; R¹⁶ represents a hydrocarbon group having from 1 to 10 carbon atoms; D represents a halogen atom, —OCOR¹⁶ or —OR¹⁶; p represents an integer of from 0 to 3; and n represents an integer of from 0 to 10.

4. The optical film according to claim 1, further comprising an additive that reduces an Rth.

5. The optical film according to claim 4, containing, as the additive, from 0.01% to 30% by weight of at least one compound represented by the following formulae (IV) or (V) based on the cyclic olefin resin on a solid basis: 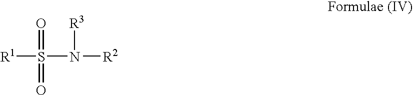
wherein R¹ represents an alkyl group or an aryl group; R² and R³ each independently represent a hydrogen atom, an alkyl group or an aryl group; provided that a total carbon atom number of R¹, R², and R³ is 10 or more; 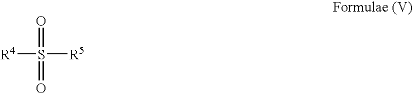
wherein R⁴ and R⁵ each independently represent an alkyl group or an aryl group, provided that a total carbon atom number of R⁴ and R⁵ is 10 or more.

6. The optical film according to claim 4, which contain, as the additive, from 0.01% to 30% by weight of at least one compound represented by the following formulae (VI), (VII) and (VIII) based on the cyclic olefin resin on a solid basis: 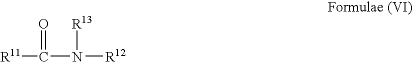
wherein R¹¹ represents an aryl group; R¹² and R¹³ each independently represent a substituted or unsubstituted alkyl group or a substituted or unsubstituted aryl group, provided that at least one of R¹² and R¹³ is an aryl group; 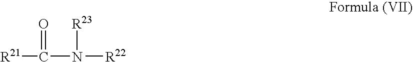
wherein R²¹, R²², and R²³ each independently represent a substituted or unsubstituted alkyl group; 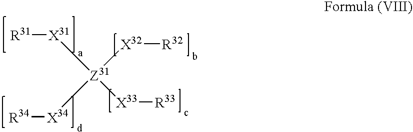
wherein R³¹, R³², R³³, and R³⁴ each independently represent a hydrogen atom, a substituted or unsubstituted aliphatic group or a substituted or unsubstituted aromatic group; X³¹, X³², X³³, and X³⁴ each independently represent a single bond or a divalent linking group composed of at least one of —CO— and NR³⁵—; R³⁵ represents a substituted or unsubstituted aliphatic group or a substituted or unsubstituted aromatic group; a, b, c, and d each independently represent an integer of 0 or greater, provided that a+b+c+d is 2 or greater; and Z³¹ represents an acylic organic group having a valence of (a+b+c+d).

7. The optical film according to claim 4, comprising 0.01% to 30% by weight of at least one compound represented by the following formula (IX) or (X) based on the cyclic olefin resin on a solid basis: 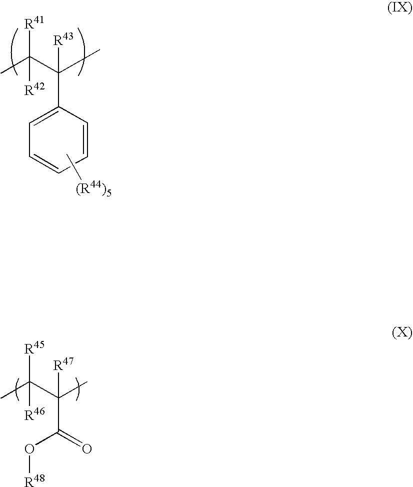
wherein R⁴¹ to R⁴⁸ each independently represent a hydrogen atom, a halogen atom, a substituted or unsubstituted hydrocarbon group having from 1 to 30 carbon atoms which may have a linking group containing an oxygen atom, a sulfur atom, a nitrogen atom or a silicon atom, or a polar group; and R⁴⁴ s may be either all the same atoms or groups or different atoms or groups, or R⁴⁴s may be bonded together to form a carbocycle or a heterocycle which may either have a monocyclic structure or be fused to another cycle to form a polycyclic structure.

8. The optical film according to claim 4, comprising 0.01% to 30% by weight of at least one polyester polymer based on the cyclic olefin resin on a solid basis.

9. A process for producing the optical film according to claim 1, comprising:
dissolving a cyclic olefin resin in an organic solvent to prepare a dope;
casting the dope on a support;
peeling the cast film from the support;
drying the cast film; and
taking up the film.

10. A polarizing plate comprising a polarizer and a protective film on each side of the polarizer, at least one of the protective films being the optical film according to claim 1.

11. A liquid crystal device comprising a liquid crystal cell and polarizing plates each disposed on each side of the liquid crystal cell, at least one of the polarizing plates being the polarizing plate according to claim 10.
